(19) United States
(12) Patent Application Publication
(10) Pub. No.: US 2002/0155381 A1
(43) Pub. Date: Oct. 24, 2002

(54) Optical data carrier comprising a light-absorbent compound having a plurality of chromophoric centres in the information layer

(76) Inventors: Horst Berneth, Leverkusen (DE); Thomas Bieringer, Odenthal - Blecher (DE); Friedrich-Karl Bruder, Krefeld (DE); Rainer Hagen, Leverkusen (DE); Karin Hassenruck, Dusseldorf (DE); Serguei Kostromine, Swisttal (DE); Rafael Oser, Krefeld (DE)

Correspondence Address: BAYER CORPORATION, PATENT DEPARTMENT, 100 BAYER ROAD, PITTSBURGH, PA, 15205, US

(21) Appl. No.: 10/102,586

(22) Filed: Mar. 20, 2002

(30) Foreign Application Priority Data
Mar. 28, 2001 (DE) 10115227.2

(51) Int. Cl. G11B 7/24

(52) U.S. Cl. 430/270.15

(57) ABSTRACT

Optical data carrier comprising a preferably transparent substrate which may, if desired, have previously been coated with a reflection layer and to whose surface a light-writeable information layer, if desired a reflection layer and if desired a protective layer or a further substrate or a covering layer have been applied, which can be written on or read by means of blue, red or infrared light, preferably laser light, where the information layer comprises a light-absorbent compound and, if desired, a binder, characterized in that the light-absorbent compound has at least two identical or different chromophoric centers and has at least one absorption maximum in the range from 340 to 820 nm.

The invention relates to a write-once optical data carrier comprising a light-absorbent compound having at least two identical or different chromophoric centres in the information layer, to a process for its production and also to the application of the abovementioned dyes to a polymer substrate, in particular polycarbonate, by spin coating or vapour deposition.

Write-once optical data carriers using specific light-absorbent substances or mixtures thereof are particularly suitable for use in high-density writeable optical data stores which operate with blue laser diodes, in particular GaN or SHG laser diodes (360-460 nm) and/or for use in DVD-R or CD-R disks which operate with red (635-660 nm) or infrared (780-830 nm) laser diodes.

The write-once compact disk (CD-R, 780 nm) has recently experienced enormous volume growth and represents the technically established system.

The next generation of optical data stores—DVDs—is currently being introduced onto the market. Through the use of shorter-wave laser radiation (635-660 nm) and higher numerical aperture NA, the storage density can be increased. The writeable format in this case is DVD-R.

Today, optical data storage formats which use blue laser diodes (based on GaN, JP 08 191 171 or Second Harmonic Generation SHG JP 09 050 629) (360 nm-460 nm) with high laser power are being developed. Writeable optical data stores will therefore also be used in this generation. The achievable storage density depends on the focusing of the laser spot on the information plane. Spot size scales with the laser wavelength λ/NA. NA is the numerical aperture of the objective lens used. In order to obtain the highest possible storage density, the use of the smallest possible wavelength λ is the aim. At present 390 nm is possible on the basis of semiconductor laser diodes.

The patent literature describes dye-based writeable optical data stores which are equally suitable for CD-R and DVD-R systems (JP-A 11 043 481 and JP-A 10 181 206). To achieve a high reflectivity and a high modulation height of the read-out signal and also to achieve sufficient sensitivity in writing, use is made of the fact that the IR wavelength of 780 nm of CD-Rs is located at the foot of the long wavelength flank of the absorption peak of the dye and the red wavelength of 635 nm or 650 nm of DVD-Rs is located at the foot of the short wavelength flank of the absorption peak of the dye. In JP-A 02 557 335, JP-A 10 058 828, JP-A 06 336 086, JP-A 02 865 955, WO-A 09 917 284 and U.S. Pat. No. 5,266,699, this concept is extended to the 450 nm working wavelength region on the short wavelength flank and the red and IR region on the long wavelength flank of the absorption peak.

Apart from the abovementioned optical properties, the writeable information layer comprising light-absorbent organic substances has to have a substantially amorphous morphology to keep the noise signal during writing or reading as small as possible. For this reason, it is particularly preferred that crystallization of the light-absorbent substances be prevented in the application of the substances by spin coating from a solution, by vapour deposition and/or sublimation during subsequent covering with metallic or dielectric layers under reduced pressure.

The amorphous layer comprising light-absorbent substances preferably has a high heat distortion resistance, since otherwise further layers of organic or inorganic material which are applied to the light-absorbent information layer by sputtering or vapour deposition would form blurred boundaries due to diffusion and thus adversely affect the reflectivity. Furthermore, a light-absorbent substance which has insufficient heat distortion resistance can, at the boundary to a polymeric support, diffuse into the latter and once again adversely affect the reflectivity.

A light-absorbent substance whose vapour pressure is too high can sublime during the abovementioned deposition of further layers by sputtering or vapour deposition in a high vacuum and thus reduce the layer thickness to below the desired value. This in turn has an adverse effect on the reflectivity.

It is therefore an object of the invention to provide suitable compounds which satisfy the high requirements (e.g. light stability, favourable signal/noise ratio, damage-free application to the substrate material, and the like) for use in the information layer in a write-once optical data carrier, in particular for high-density writeable optical data store formats in a laser wavelength range from 340 to 830 nm.

Surprisingly, it has been found that light-absorbent substances having a plurality of chromophoric centres can satisfy the abovementioned requirement profile particularly well.

The invention accordingly provides an optical data carrier comprising a preferably transparent substrate which may, if desired, have previously been coated with one or more reflection layers and to whose surface a light-writeable information layer, if desired one or more reflection layers and if desired a protective layer or a further substrate or a covering layer have been applied, which can be written on or read by means of blue, red or infrared light, preferably laser light, where the information layer comprises a light-absorbent compound and, if desired, a binder, characterized in that the light-absorbent compound has at least two identical or different chromophoric centres and has at least one absorption maximum in the range from 340 to 820 nm.

Light-Absorbent Compound (Physical Definition)

For the purposes of the present patent application, a “chromophoric centre” is a part of the molecule of a light-absorbing compound which has an absorption maximum in the range from 340 to 820 nm. This part of the molecule is preferably a monovalent group (radical).

Preference is given to light-absorbent compounds which have an absorption maximum λₘₐₓ₁ in the range from 340 to 410 nm or an absorption maximum λₘₐₓ₂ in the range from 400 to 650 nm or an absorption maximum λₘₐₓ₃ in the range from 630 to 820 nm, where the wavelength λ_{1/2} at which the absorbance in the long wavelength flank of the absorption maximum at the wavelength λₘₐₓ₁, λₘₐₓ₂ or λₘₐₓ₃ or the absorbance in the short wavelength flank of the absorption maximum at the wavelength λₘₐₓ₂ or λₘₐₓ₃ is half the absorbance at λₘₐₓ₁, λₘₐₓ₂ or λₘₐₓ₃ and the wavelength λ_{1/10} at which the absorbance in the long wavelength flank of the absorption maximum at the wavelength λₘₐₓ₁, λₘₐₓ₂ or λₘₐₓ₃ or the absorbance in the short wavelength flank of the absorption maximum at the wavelength λₘₐₓ₂ or λₘₐₓ₃ is one tenth of the absorbance at λₘₐₓ₁, λₘₐₓ₂ or λₘₐₓ₃ are preferably not more than 80 nm apart in each case.

The physical characterization of the light-absorbent compound applies in the same way to the chromophoric centres, i.e. shape and position of the absorption bands apply equally to the light-absorbent compound and the chromophoric centre in a preferred embodiment.

The light-absorbent compound should preferably be able to be changed thermally. The thermal change preferably occurs at a temperature of <600° C., particularly preferably at a temperature of <400° C., very particularly preferably at a temperature of <300° C., in particular <200° C. Such a change can be, for example, a decomposition or chemical change of the chromophoric centre of the light-absorbent compound.

In a preferred embodiment of the invention, the absorption maximum mal of the light-absorbent compound is in the range from 340 to 410 nm, preferably from 345 to 400 nm, in particular from 350 to 380 nm, particularly preferably from 360 to 370 nm, where the wavelength λ_{1/2} at which the absorbance in the long wavelength flank of the absorption maximum at the wavelength λₘₐₓ₃ is half the absorbance at λₘₐₓ₁ and the wavelength λ_{1/10} at which the absorbance in the long wavelength flank of the absorption maximum at the wavelength λₘₐₓ₃ is one tenth of the absorbance at λₘₐₓ₁ must in each case be no more than 50 nm apart. Such a light-absorbent compound preferably has no longer-wavelength maximum λₘₐₓ₂ up to a wavelength of 500 nm, particularly preferably 550 nm, very particularly preferably 600 nm.

In such light-absorbent compounds, λ_{1/2} and kilo, as defined above, are preferably not more than 40 nm apart, particularly preferably not more than 30 rum apart, very particularly preferably not more than 10 nm apart.

In a further embodiment of the invention, the absorption maximum λₘₐₓ₂ of the light-absorbent compound(s) is in the range from 420 to 550 nm, preferably from 410 to 510 nm, in particular from 420 to 510 nm, particularly preferably from 430 to 500 nm, where the wavelength λ_{1/2} at which the absorbance in the short wavelength flank of the absorption maximum at the wavelength λₘₐₓ₂ is half the absorbance at max and the wavelength λ_{1/10} at which the absorbance in the short wavelength flank of the absorption maximum at the wavelength λₘₐₓ₂ is one tenth of the absorbance at a must in each case be no more than 50 nm apart. Such a light-absorbent compound preferably has no shorter-wavelength maximum λₘₐₓ₁ down to a wavelength of 350 nm, particularly preferably 320 run, very particularly preferably 290 nm.

In these compounds, λ_{1/2} and λ_{1/10}, as defined above, are preferably not more than 40 nm apart, particularly preferably not more than 30 nm apart, very particularly preferably not more than 20 nm apart.

In a further embodiment of the invention, the absorption maximum λₘₐₓ₂ of the light-absorbent compound(s) is in the range from 500 to 650 mm, preferably from 530 to 630 nm, in particular from 550 to 620 m, particularly preferably from 580 to 610 nm, where the wavelength λ_{1/2} at which the absorbance in the long wavelength flank of the absorption maximum at the wavelength λₘₐₓ₂ is half the absorbance at λₘₐₓ₂ and the wavelength λ_{1/10} at which the absorbance in the long wavelength flank of the absorption maximum at the wavelength λₘₐₓ₂ is one tenth of the absorbance at λₘₐₓ₂ must in each case be no more than 50 nm apart. Such a compound preferably has no longer-wavelength maximum λₘₐₓ₃ up to a wavelength of 750 nm, particularly preferably 800 nm, very particularly preferably 850 nm.

In these light-absorbent compound(s), λ_{1/2} and λ_{1/10}, as defined above, are preferably not more than 40 nm apart, particularly preferably not more than 30 nm apart, very particularly preferably not more than 10 nm apart.

In a further embodiment of the invention, the absorption maximum λₘₐₓ₃ of the light-absorbent compound(s) is in the range from 630 to 800 nm, preferably from 650 to 770 nm, in particular from 670 to 750 nm, particularly preferably from 680 to 720 nm, where the wavelength λ_{1/2} at which the absorbance in the short wavelength flank of the absorption maximum at the wavelength λₘₐₓ₃ is half the absorbance at λₘₐₓ₃ and the wavelength λ_{1/10} at which the absorbance in the short wavelength flank of the absorption maximum at the wavelength λₘₐₓ₃ is one tenth of the absorbance at λₘₐₓ₃ must in each case be no more than 50 nm apart. Such a compound preferably has no shorter-wavelength maximum )max down to a wavelength of 600 nm, particularly preferably 550 nm, very particularly preferably 500 nm.

In these light-absorbent compound(s), λ_{1/a} and λ_{1/10}, as defined above, are preferably not more than 40 nm apart, particularly preferably not more than 30 nm apart, very particularly preferably not more than 20 nm apart.

In a further embodiment of the invention, the absorption maximum λₘₐₓ₃ of the light-absorbent compound(s) is in the range from 650 to 810 um, preferably from 660 to 790 nm, in particular from 670 to 760 nm, particularly preferably from 680 to 740 nm, where the wavelength λ_{1/2} at which the absorbance in the long wavelength flank of the absorption maximum at the wavelength λₘₐₓ₃ is half the absorbance at λₘₐₓ₃ and the wavelength λ_{1/10} at which the absorbance in the long wavelength flank of the absorption maximum at the wavelength λₘₐₓ₃ is one tenth of the absorbance at λₘₐₓ₃ are preferably no more than 50 nm apart.

In these compounds, λ_{1/2} and λ_{1/10}, as defined above, are preferably not more than 40 nm apart, particularly preferably not more than 30 nm apart, very particularly preferably not more than 10 nm apart.

The light-absorbent compounds preferably have a molar extinction coefficient F of >10 000 l/mol cm, preferably >15 000 l/mol cm, particularly preferably >20 000 l/mol cm, very particularly preferably >25 000 l/mol cm, in particular >30 000 l/mol cm, most preferably >40 000 l/mol cm, at the absorption maximum λₘₐₓ₁, λₘₐₓ₂ and/or λₘₐₓ₃.

Light-Absorbent Compound (Chemical Definitions)

The light-absorbent compounds can, for example, be in the form of polymers, e.g. as homopolymers, copolymers or graft polymers, dendrimers or in another form.

Preference is given to linear homopolymers whose repeating units bear the chromophoric centres. Particular preference is given to polymers of the formula (I). Preference is likewise given to light-absorbent compounds in dendritic form, where the chromophoric centres are preferably located at the ends of a molecule having a dendritic structure. Particular preference is given to dendrimers of the formula (II).

Preference is likewise given to light-absorbent compounds in the form of side-chain polymers in which the chromophoric centres are preferably bound in an appropriate manner to a polymer chain.

As light-absorbent compound in the information layer of an optical data carrier, preference is given to using a compound of the formula

F¹—(BF²)ₙBF¹ (I)

DFₖ (II),

or a polymer having a main chain acting as backbone and covalently bound side groups of the formula (III)

—S—F¹ (III)

branching off therefrom, where the polymer has a degree of polymerization of from 2 to 1 000,

where

F¹ represents a monovalent chromophoric centre,

F² represents a bivalent chromophoric centre,

B represents a bivalent bridge —B¹— or —(B²F¹)— or —(B³F¹₂)—,

where

B² is a trivalent radical and B³ is a tetravalent radical,

D represents a dendritic structure of the generation 21,

S represents a bivalent spacer group,

n represents an integer from 0 to 1 000,

k represents the number 3·2¹ or 4·2¹,

l represents an integer from 0 to 6.

As preferred light-absorbent compounds, mention may be made of those of the formulae (I) and (II)

in which B¹

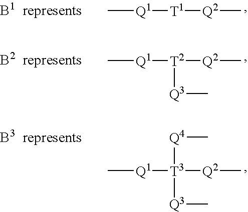

D represents a radical of the formulae

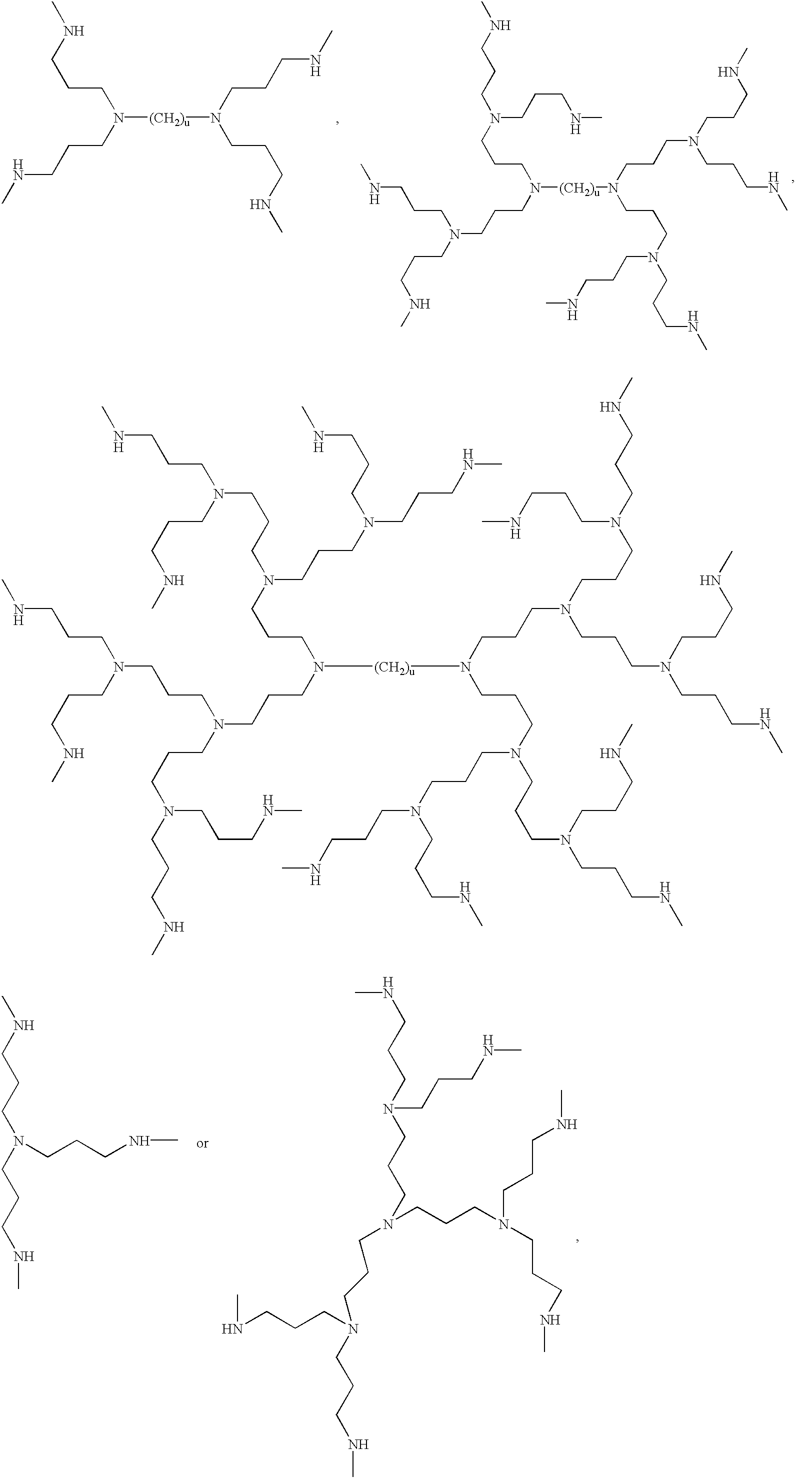

Q¹ to Q⁶ represent, independently of one another, a direct bond, —O—, —S—, —NR¹—, —C(R²R³)—, —(C═O)—, —(CO—O)—, —(CO—NR¹)—, —(SO₂)—, —(SO₂—O)—, —(SO₂—NR¹)—, —(C═NR⁴)—, —(CNR¹—NR⁴)—, —(CH₂)ₚ—, —(CH₂CH₂O)ₚ—CH₂CH₂—, o-, m- or p-phenylene, where the chain —(CH₂)ₚ— may be interrupted by —O—, —NR¹— or —OSiR⁵₂O—,

T¹ and T⁴ represent, independently of one another, a direct bond, —(CH₂)ₚ— or o-, m- or p-phenylene, where the chain —(CH₂)ₚ— may be interrupted by —O—, —NR— or —OSiR⁵₂O—,

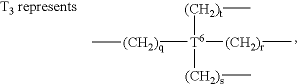

T⁵ represents CR⁶, N or a trivalent radical of the formula

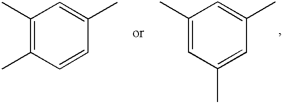

T⁶ represents C, Si(O—)₄, >N—(CH₂)ᵤ—N< or a tetravalent radical of the formula

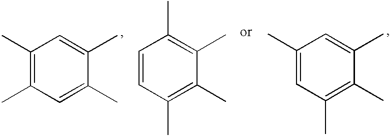

p represents an integer from 1 to 12,

q, r, s and t represent, independently of one another, an integer from 0 to 12,

u represents an integer from 2 to 4,

R¹ represents hydrogen, C₁-C₁₂-alkyl, C₃-C₁₀-cycloalkyl, C₂-C₁₂-alkenyl, C₆-C₁₀-aryl, C₁-C₁₂-alkyl-(C═O)—, C₃-C₁₀-cycloalkyl-(C═O)—, C₂-C₁₂-alkenyl-(C═O)—, C₆-C₁₀-aryl-(C═O)—, C₁-C₁₂-alkyl-(SO₂)—, C₃-C₁₀-cycloalkyl-(SO₂)—, C₂-C₁₂-alkenyl-(SO₂)— or C₆-C₁₀-aryl-(SO₂)—,

R² to R⁴ and R⁶ represent, independently of one another, hydrogen, C₁-C₁₂-alkyl, C₃-C₁₀-cycloalkyl, C₂-C₁₂-alkenyl, C₆-C₁₀-aryl,

R⁵ represents methyl or ethyl and

the other radicals are as defined above.

n is preferably an integer from 0 to 10, particularly preferably from 0 to 2, very particularly preferably 0. 1 is preferably an integer from 0 to 3, particularly preferably 0 or 1.

Preferred polymers bearing radicals of the formula (III) as light-absorbent compounds are ones in which the polymer chain is built up on the basis of identical or different structural elements K and

K represents a structural element of a poly-acrylate, -methacrylate, -acrylamide, -methacrylamide, -siloxane, -α-oxirane, -ether, -amide, -urethane, -urea, -ester, -carbonate, -styrene or -maleic acid and

the other radicals are as defined above.

Preference is given to

S representing a spacer group of the formula —Q⁵—T⁴—Q⁶— which connects the main chain of the side-chain polymer to the chromophoric centre F¹.

Preference is given to poly-acrylates, -methacrylates and -esters. Preference is likewise given to copolymers comprising acrylate or methacrylate and acrylamide units. Particular preference is given to poly-acrylates and -methacrylates. In these cases,

K represents

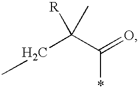

where

R represents hydrogen or methyl and

the asterisked (*) bond leads to the bivalent spacer group S.

Particular preference is likewise given to copolymers in which K represents K′ and K″ where

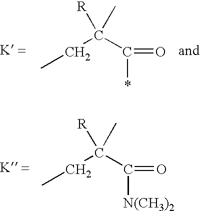

where

R represents hydrogen or methyl and the asterisked (*) bond leads to the bivalent spacer group S.

Preference is given to a degree of polymerization of from 2 to 100, particularly preferably from 2 to 20.

The chromophoric centres of the light-absorbent compounds can be, for example, radicals of the following structural types (cf., for example, G. Ebner and D. Schulz, Textilfarberei und Farbstoffe, Springer-Verlag, Berlin Heidelberg, 1989; H. Zollinger, Color Chemistry, VCH Verlagsgesellschaft mbH Weinheim, 1991):

azo dyes, anthraquinoid dyes, indigoid dyes, polymethine dyes, arylcarbonium dyes, phthalocyanine dyes, nitro dyes, perylenes, coumarins, formazanes, metal complexes, in particular

bridged or unbridged (hetero)cinnamic acid derivatives, (hetero)stilbenes, coumarins, methines, cyanines, hemicyanines, neutromethines (merocyanines), nullmethines, azomethines, hydrazones, azine dyes, triphendioxazines, pyronines, acridines, rhodamines, indamines, indophenols, di- or triphenylmethanes, aryl- and hetaryl azo dyes, quinoid dyes, phthalocyanines, naphthocyanines, subphthalocyanines, porphyrins, tetraazaporphyrins and metal complexes.

Preferred light-absorbent compounds having an absorption maximum λₘₐₓ₁ in the range from 340 to 410 nm are, for example, those of the following formulae. Corresponding optical data carriers comprising these compounds in the information layer can be read and written on by means of blue or red light, in particular laser light:

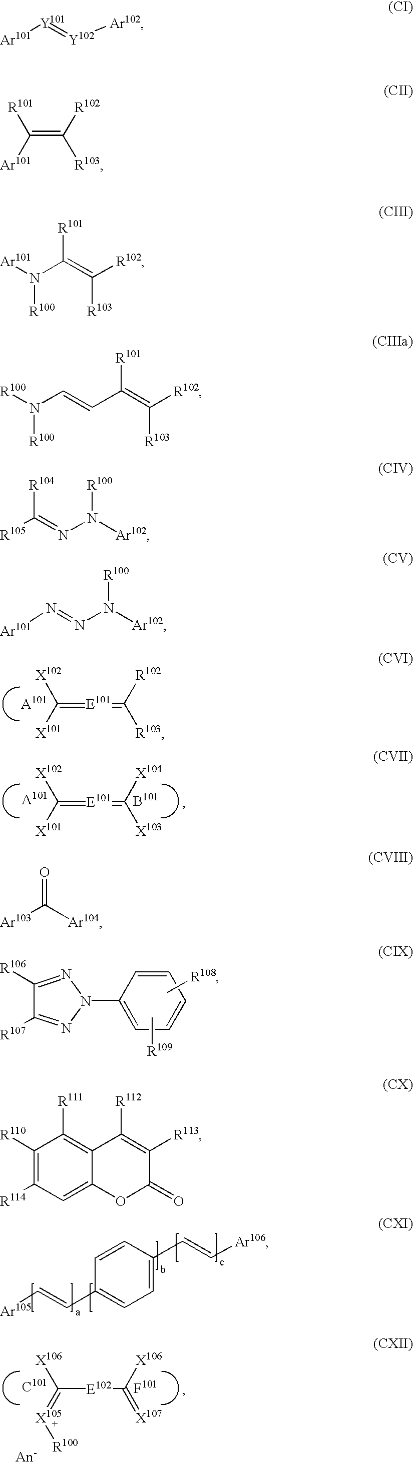

where

Ar¹⁰¹ and Ar¹⁰² represent, independently of one another, C₆-C₁₀-aryl or the radical of a five- or six-membered aromatic, pseudoaromatic or partially hydrogenated heterocyclic ring, which may be benzo- or naphtho-fused and/or substituted by nonionic radicals,

Y¹⁰¹ and Y¹⁰² represent, independently of one another, N or C—R¹⁰¹ or

Y¹⁰¹═Y¹⁰² may be a direct bond,

R¹⁰¹ and R¹⁰⁴ represent, independently of one another, hydrogen, C₁-C₁₆-alkyl, cyano, carboxyl, C₁-C₁₆-alkoxycarbonyl, C₁-C₁₆-alkanoyl or Ar¹⁰², or R¹⁰¹ represents a bridge to Ar¹⁰¹,

R¹⁰² and R¹⁰³ represent, independently of one another, cyano, nitro, carboxyl, C₁-C₁₆-alkoxycarbonyl, aminocarbonyl or C₁-C₁₆-alkanoyl, or R¹⁰² represents hydrogen, halogen, C₁-C₁₆-alkyl or a radical of the formula

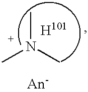

or R¹⁰³ represents Ar¹⁰², CH₂—COOalkyl or P(O)(O—C₁-C₁₂-alkyl)₂ or C₁-C₁₆-alkyl or R¹⁰²; R¹⁰³ together with the carbon atom connecting them represent a five- or six-membered carbocyclic or aromatic, pseudoaromatic or partially hydrogenated heterocyclic ring which may be benzo- or naphtho-fused and/or be substituted by nonionic radicals, or R¹⁰³ forms a bridge to Ar¹⁰¹ or ring A¹⁰¹ which may contain a heteroatom and/or be substituted by nonionic radicals,

R¹⁰⁰ represents hydrogen, C₁-C₁₆-alkyl, C₇-C₁₆-aralkyl or R¹⁰¹ or NR¹⁰⁰R¹⁰⁰ represents pyrrolidino, piperidino or morpholino or

R¹⁰⁰ and R¹⁰⁴ together represent a —CH₂—CH₂— or —CH₂—CH₂—CH₂— bridge, R¹⁰⁵ represents cyano, carboxyl, C₁-C₁₆-alkoxycarbonyl, aminocarbonyl, C₁-C₁₆-alkanoyl or Ar¹⁰¹ or R¹⁰⁴; R¹⁰⁵ together with the carbon atom connecting them represent a five- or six-membered carbocyclic or aromatic, pseudoaromatic or partially hydrogenated heterocyclic ring, which may be benzo- or naphtho-fused and/or be substituted by nonionic radicals,

X¹⁰¹, X¹⁰², X¹⁰³, X¹⁰⁴, X¹⁰⁶, X¹⁰⁹ and X¹¹⁰ represent, independently of one another, O, S, or N—R¹⁰⁰ or X¹⁰², X¹⁰⁴ or X¹⁰⁶ may also be CH or CR¹⁰⁰R¹⁰⁰,

A¹⁰¹, B¹⁰¹, C¹⁰¹, F¹⁰¹, G¹⁰¹ and H¹⁰¹ represent, independently of one another, a five- or six-membered aromatic, pseudoaromatic or partially hydrogenated heterocyclic ring which may be benzo- or naphtho-fused and/or be substituted by nonionic radicals,

X¹⁰⁵ and X¹⁰⁸ represent, independently of one another, N,

E¹⁰¹ represents a direct double bond, ═CH—CH═, ═N—CH═ or ═N—N═,

E¹⁰² represents a direct bond, —CH═CH—, —N═CH— or —N═N—,

Ar¹⁰³ and Ar¹⁰⁴ represent, independently of one another, 2-hydroxyphenyl radicals which may be benzo-fused and/or be substituted by hydroxy, C₁-C₁₆-alkoxy or C₆-C₁₀-aryloxy,

R¹⁰⁶ and R¹⁰⁷ represent, independently of one another, hydrogen, C₁-C₁₆-alkyl or C₆-C₁₀-aryl or together represent a —CH═CH—CH═CH— or o-C₆H₄—CH═CH—CH═CH— bridge,

R¹⁰⁸ represents C₁-C₁₆-alkyl, CHO, CN, CO—C₁-C₈-alkyl, CO—C₆-C₁₀-aryl or CH═C(CO—C₁-C₈-alkyl)—CH₂—CO—C₁-C₈-alkyl,

R¹⁰⁹ represents hydroxy or C₁-C₁₆-alkoxy,

R¹¹⁰ and R¹¹¹ represent hydrogen or together represent a —CH═CH—CH═CH— bridge,

R¹¹² represents hydrogen, C₁-C₁₆-alkyl or cyano,

R¹¹³ represents hydrogen, cyano, C₁-C₄-alkoxycarbonyl, C₆-C₁₀-aryl, thien-2-yl, pyrid-2- or S-4yl, pyrazol-1-yl or 1,2,4-triazol-1- or -4-yl, which may be benzo- or naphtho-fused and/or be substituted by nonionic radicals,

R¹¹⁴ represents hydrogen, C₁-C₁₆-alkoxy, 1,2,3-triazol-2-yl which may be substituted by nonionic radicals, C₁-C₁₆-alkanoylamino, C₁-C₈-alkanesulphonylamino or C₆-C₁₀-arylsulphonylamino,

Ar¹⁰⁵ and Ar¹⁰⁶ represent, independently of one another, C₆-C₁₀-aryl or the radical of a five- or six-membered aromatic, pseudoaromatic or partially hydrogenated heterocyclic ring, which may be benzo- or naphtho-fused and/or be substituted by nonionic radicals and/or by sulpho,

a, b and c represent, independently of one another, an integer from 0 to 2,

X¹⁰⁷ represents N or N⁺—R¹⁰⁰ An⁻,

An⁻ represents an anion,

E¹⁰³ represents N, CH, C—CH₃ or C—CN,

R¹¹⁵ and R¹¹⁶ represent, independently of one another, hydrogen or C₁-C₁₆-alkyl,

R¹¹⁷ and R¹¹⁸ represent, independently of one another, hydrogen, C₁-C₁₆-alkyl, cyano or C₁-C₁₆-alkoxycarbonyl,

R¹¹⁹ represents hydrogen, C₁-C₁₆-alkyl, C₁-C₁₆-alkoxy or 2 radicals R¹¹⁹ of a thiophene ring represent a bivalent radical of the formula —O—CH₂—CH₂—O—,

Y¹⁰³ and Y¹⁰⁴ represent, independently of one another, O or N—CN,

R¹²⁰ to R¹²¹ represent, independently of one another, hydrogen, C₁-C₁₆-alkyl, C₁-C₁₆-alkoxy, cyano, C₁-C₁₆-alkoxycarbonyl, halogen, Ar¹⁰¹, Ar¹⁰² or

R¹²⁰ together with R¹²¹ and/or R¹²² together with R¹²³ represent a —CH═CH—CH═CH— or o-C₆H₄—CH═CH—CH═CH— bridge which may be substituted by nonionic substituents,

R¹²⁴ represents C₁-C₁₆-alkyl, C₁-C₁₆-alkoxy, cyano, C₁-C₁₆-alkoxycarbonyl, carboxyl, C₁-C₁₆-alkylaminocarbonyl or C₁-C₁₆-dialkylaminocarbonyl,

R¹²⁵ and R¹²⁶ represent, independently of one another, hydrogen, C₁-C₁₆-alkyl, C₁-C₁₆-alkoxy, cyano, C₁-C₁₆-alkoxycarbonyl, hydroxy, carboxyl or C₆-C₁₀-aryloxy,

e, f and g represent, independently of one another, an integer from 1 to 4, where, if e, f or g >1, the radicals may be different,

X¹¹¹ represents N or C—Ar¹⁰²,

R¹²⁷ represents hydrogen, C₁-C₁₆-alkyl or C₆-C₁₀-aryl,

R¹²⁸ and R¹²⁹ represent, independently of one another, hydrogen, C₁-C₁₆-alkyl, C₆-C₁₀-aryl or C₇-C₁₅-aralkyl or

NR¹²⁸R²⁹ represents morpholino, piperidino or pyrrolidino,

R¹³⁰ represents C₁-C₁₆-allyl, C₇-C₁₅-aralkyl or Ar¹,

R¹³¹ and R¹³² represent, independently of one another, hydrogen, C₁-C₁₆-alkyl, C₁-C₁₆-alkoxy, cyano, C₁-C₁₆-alkoxycarbonyl, halogen or C₆-C₁₀-aryl or together represent a bridge of the formula —CO—N(R¹³⁰)—CO—, and the radicals M³⁰⁰, R³⁰⁶ to R³⁰⁹ and w to z of the formula (CCCIX) are described in more detail below,

with bonding to the bridge B, the dendritic structure D or the spacer group S being via the radicals R¹⁰⁰ to R¹³², M³⁰⁰, R³⁰⁶ to R³⁰⁹ or via the nonionic radicals by which Ar¹⁰¹ to Ar¹⁰⁶ and the rings A¹⁰¹ to H¹⁰¹ may be substituted. In this case, these radicals represent a direct bond.

Nonionic radicals are C₁-C₄-alkyl, C₁-C₄-alkoxy, halogen, cyano, nitro, C₁-C₄-alkoxycarbonyl, C₁-C₄-alkylthio, C₁-C₄-alkanoylamino, benzoylamino, mono- or di-C₁-C₄-alkylamino.

Alkyl, alkoxy, aryl and heterocyclic radicals may, if desired, bear further radicals such as alkyl, halogen, nitro, cyano, CO—NH₂, alkoxy, trialkylsilyl, trialkylsiloxy or phenyl, the alkyl and alkoxy radicals may be straight-chain or branched, the alkyl radicals may be partially halogenated or perhalogenated, the alkyl and alkoxy radicals may be ethoxylated or propoxylated or silylated, adjacent alkyl and/or aLkoxy radicals on aryl or heterocyclic radicals may together form a three- or four-membered bridge and the heterocyclic radicals may be benzo-fused and/or quaternized.

Particular preference is given to light-absorbent compounds of the formulae (CI) to (CXXI), (CIIIa) and (CCCIX),

where

Ar¹⁰¹ and Ar¹⁰² represent, independently of one another, phenyl, naphthyl, benzothiazol-2-yl, benzoxazol-2-yl, benzimidazol-2-yl, thiazol-2-yl, thiazolin-2-yl, pyrrolin-2-yl, isothiazol-3-yl, imidazol-2-yl, 1,3,4-thiadiazol-2-yl, 1,3,4-triazol-2-yl, 2- or 4-pyridyl, 2- or 4-quinolyl, pyrrol-2- or -3-yl, thiophen-2- or -3-yl, furan-2- or -3-yl, indol-2- or -3-yl, benzothiophen-2-yl, benzofuran-2-yl or 3,3-dimethylindolen-2-yl, which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, dimethylamino, diethylamino, dipropylamino or dibutylamino,

Y¹⁰¹ and Y¹⁰² represent, independently of one another, N or C—R¹⁰¹ or

Y¹⁰¹═Y¹⁰² may represent a direct bond,

R¹⁰¹ and R¹⁰⁴ represent, independently of one another, hydrogen, methyl, ethyl, propyl, butyl, cyano, carboxyl, methoxycarbonyl, ethoxycarbonyl, acetyl, propionyl or Ar¹⁰², or Ar¹⁰¹ and R¹⁰¹ together represent a ring of the formula

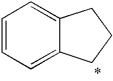

which may be substituted by methyl, ethyl, propyl, butyl, methoxy, ethoxy, propoxy, butoxy, where the asterisk (*) indicates the ring atom from which the double bond extends,

R¹⁰², R¹⁰³ and R¹⁰⁵ represent, independently of one another, cyano, carboxyl, methoxycarbonyl, ethoxycarbonyl, propoxycarbonyl, butoxycarbonyl, methoxyethoxycarbonyl, acetyl, propionyl or butanoyl or R¹⁰² represents hydrogen, or a radical of the formula

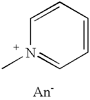

or R¹⁰³ represents Ar¹⁰² or R¹⁰⁵ represents Ar¹⁰¹ or R⁰²; R¹⁰³ or R¹⁰⁴; R¹⁰⁵ together with the carbon atom connecting them represent a ring of the formula

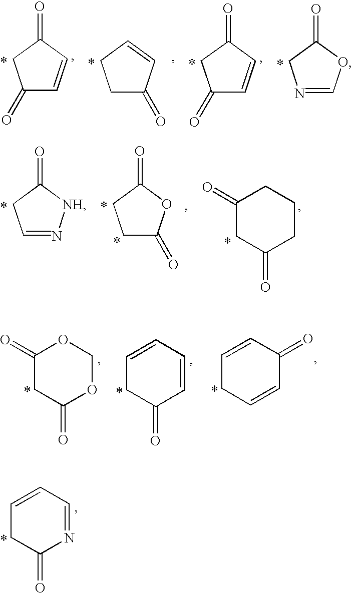

which may be benzo- or naphtho-fused and/or be substituted by nonionic radicals, where the asterisk (*) indicates the ring atom from which the double bond extends, or R¹⁰³ represents a —CH₂—, —C(CH₃)₂—, —O—, —NH—, —N(CH₃)—, —N(C₂H₅)—, —N(COCH₃)—, N(COC₄H₉)— or —N(COC₆H₅)— bridge which is bound to the 2 position (relative to the site of substitution) of Ar¹⁰¹ or ring A¹⁰¹,

R¹⁰⁰ represents hydrogen, methyl, ethyl, propyl, butyl or benzyl or

NR¹⁰⁰R¹⁰⁰ represents pyrrolidino, morpholino or piperidino or

R¹⁰⁰ and R¹⁰ together represent a —CH₂—CH₂— bridge or

two radicals R¹⁰⁰ in formula (CVII) or (CXIII) represent a —CH₂—CH₂— or —CH₂—CH₂—CH₂— bridge,

A¹⁰¹, B¹⁰¹ and G¹⁰¹ represent, independently of one another, benzothiazol-2-ylidene, benzoxazol-2-ylidene, benzimidazol-2-ylidene, thiazol-2-ylidene, thiazolin-2-ylidene, pyrrolin-2-ylidene, isothiazol-3-ylidene, imidazol -2-ylidene, 1,3,4-thiadiazol-2-ylidene, 1,3,4-triazol-2-ylidene, pyridin -2- or 4-ylidene, quinolin-2- or 4-ylidene, pyrrol-2- or -3-ylidene, thiophen-2- or -3-ylidene, furan-2- or -3-ylidene, indol-2- or -3-ylidene, benzothiophen-2-ylidene, benzofuran-2-ylidene or 3,3-dimethylindolen-2-ylidene and A and B may also be 1,3-dithiol-2-ylidene or benzo-1,3-dithiol-2-ylidene, which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino or benzoylamino,

C¹⁰¹ and F¹⁰¹ represent, independently of one another, benzothiazol-2-yl, benzoxazol-2-yl, benzimidazol-2-yl, thiazol-2-yl, thiazolin-2-yl, pyrrolin-2-yl, isothiazol-3-yl, imidazol-2-yl, 1,3,4-thiadiazol-2-yl, 1,3,4-triazol-2-yl, 2- or 4-pyridyl, 2- or 4-quinolyl, pyrrol-2- or -3-yl, thiophen-2- or -3-yl, furan-2- or -3-yl, indol-2- or -3-yl, benzothiophen-2-yl, benzofuran-2-yl or 3,3-dimethylindolen-2-yl, which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino or benzoylamino, where

X¹⁰¹, X¹⁰², X¹⁰³, X¹⁰⁴, X¹⁰⁶, X¹⁰⁹ and X¹¹⁰ represent, independently of one another, O, S or N—R¹⁰⁰ and X¹⁰², X¹⁰⁴ or X¹⁰⁶ may also be CH or X¹⁰⁵ and X¹⁰⁸ represent, independently of one another, N,

X¹⁰⁷ represents N or N⁺—R¹⁰⁰ An⁻ and

An⁻ represents an anion,

E¹⁰¹ represents a direct double bond or ═N—N═,

Ar¹⁰³ and Ar¹⁰⁴ represent, independently of one another, 2-hydroxyphenyl radicals which may be substituted by hydroxy, methoxy, ethoxy, propoxy, butoxy or phenoxy,

R¹⁰⁶ and R¹⁰⁷ represent, independently of one another, hydrogen, methyl, ethyl, propyl, butyl or phenyl or together represent a —CH═CH—CH═CH— or o-C₆H₄—CH═CH—CH═CH— bridge,

R¹⁰⁸ represents methyl, ethyl, propyl, butyl, CHO, CN, acetyl, propionyl or benzoyl,

R¹⁰⁹ represents hydroxy, methoxy, ethoxy, propoxy or butoxy,

R¹¹⁰ and R¹¹¹ represent hydrogen or together represent a —CH═CH—CH═CH— bridge,

R¹¹² represents hydrogen or methyl,

R¹¹³ represents hydrogen, cyano, methoxycarbonyl, ethoxycarbonyl, phenyl, thien-2-yl, pyrid-2- or -4-yl, pyrazol-1-yl or 1,2,4-triazol-1- or 4-yl, which may be substituted by methyl, methoxy or chlorine,

R¹¹⁴ represents hydrogen, methoxy, ethoxy, propoxy, butoxy, 1,2,3-triazol -2-yl which may be substituted by methyl and/or phenyl, acetylamino, methanesulphonylamino or benzenesulphonylamino,

Ar¹⁰⁵ and Ar¹⁰⁶ represent, independently of one another, phenyl, benzothiazol-2-yl, benzoxazol-2-yl, benzimidazol-2-yl, thiazol-2-yl, thiazolin-2-yl, pyrrolin-2-yl, isothiazol-3-yl, imidazol-2-yl, 1,3,4-triazol-2-yl, 2- or 4-pyridyl, 2- or 4-quinolyl, thiophen-2- or -3-yl, furan-2- or -3-yl, benzothiophen-2-yl or benzofuran-2-yl, which may be substituted by methyl, ethyl, propyl, butyl, methoxy, ethoxy, propoxy, butoxy, chlorine, bromine, iodine, cyano, nitro, methoxycarbonyl, ethoxycarbonyl or sulpho,

a, b and c represent, independently of one another, an integer from 0 to 1,

E¹⁰² represents a direct bond, —CH═CH— or —N═CH—,

E¹⁰³ represents N or C—CN,

R¹¹⁵ and R¹¹⁶ represent, independently of one another, hydrogen, methyl or ethyl,

R¹¹⁷ and R¹¹⁸ represent, independently of one another, hydrogen, methyl, ethyl, propyl, butyl, cyano, methoxycarbonyl or ethoxycarbonyl,

R¹¹⁹ represents hydrogen, methyl, methoxy, ethoxy or 2 radicals R¹¹⁹ of a thiophene ring represent a bivalent radical of the formula —O—CH₂CH₂—O—,

Y¹⁰³ and Y¹⁰⁴ represent, independently of one another, O or N—CN,

R¹²⁰to R¹²³ represent, independently of one another, hydrogen, methyl, ethyl, propyl, butyl, methoxy, ethoxy, propoxy, butoxy, cyano, methoxycarbonyl, ethoxycarbonyl, chlorine, bromine, or

R¹²⁰ together with R¹²¹ and/or R¹²² together with R¹²³ represent a —CH═CH—CH═CH— bridge,

R¹²⁴ represents methyl, ethyl, propyl, butyl, methoxy, ethoxy, propoxy, butoxy, cyano, methoxycarbonyl or ethoxycarbonyl,

R¹²⁵ and R¹²⁶ represent, independently of one another, hydrogen, methyl, ethyl, propyl, butyl, methoxy, ethoxy, propoxy, butoxy, cyano, methoxycarbonyl, ethoxycarbonyl or hydroxy, where at least one of the radicals R¹²⁶ is located in the ring position 1 or 3 and is methoxy, ethoxy, propoxy or butoxy,

e, f and g represent, independently of one another, 1 or 2, where, if e, f or g>1, the radicals may be different,

X¹¹¹ represents N or C—Ar¹⁰²,

R¹²⁷ represents hydrogen, methyl, ethyl, propyl, butyl or phenyl,

R¹²⁸ and R¹²⁹ represent, independently of one another, hydrogen, methyl, ethyl, propyl, butyl, phenyl or benzyl or

NR¹²⁸R¹²⁹ represents morpholino, piperidino or pyrrolidino,

R¹³⁰ represents methyl, ethyl, propyl, butyl, methoxyethyl, ethoxyethyl, methoxypropyl, benzyl, phenethyl or Ar¹,

R¹³¹ and R¹³² represent, independently of one another, hydrogen, methyl, ethyl, propyl, butyl, methoxy, ethoxy, propoxy, butoxy, methoxycarbonyl, ethoxycarbonyl, chlorine or bromine or together represent a bridge of the formula —CO—N(R¹³⁰)—CO—,

M³⁰⁰ represents 2H atoms, Al, Si, Ge, Zn, Mg or Ti^{IV}, where in the case of M³⁰⁰ being Al, Si, Ge or Ti^{IV} it bears one or two further substituents or ligands R³¹³ and/or R³¹⁴ which are arranged axially relative to the phthalocyanine plane,

R³⁰⁶ to R³⁰⁹ represent, independently of one another, methyl, ethyl, propyl, butyl, methoxy or chlorine,

w to z represent, independently of one another, an integer from 0 to 4,

R³¹³ and R³¹⁴ represent, independently of one another, methyl, ethyl, phenyl, hydroxy, fluorine, chlorine, bromine, methoxy, ethoxy, phenoxy, tolyloxy, cyano or ═O,

and the radicals R³⁰⁶ to R³⁰⁹, M³⁰⁰ and w to z may also have the meanings defined below,

where bonding to the bridge B, the dendritic structure D or the spacer group S is via the radicals R¹⁰⁰ to R¹³², via the radicals by which Ar¹⁰¹ to Ar¹⁰⁶ and the rings A¹⁰¹ to G¹⁰¹ may be substituted, via R³⁰⁶ to R³⁰⁹, R³¹³ or R³¹⁴. In this case, these radicals represent a direct bond.

The following examples serve to illustrate:

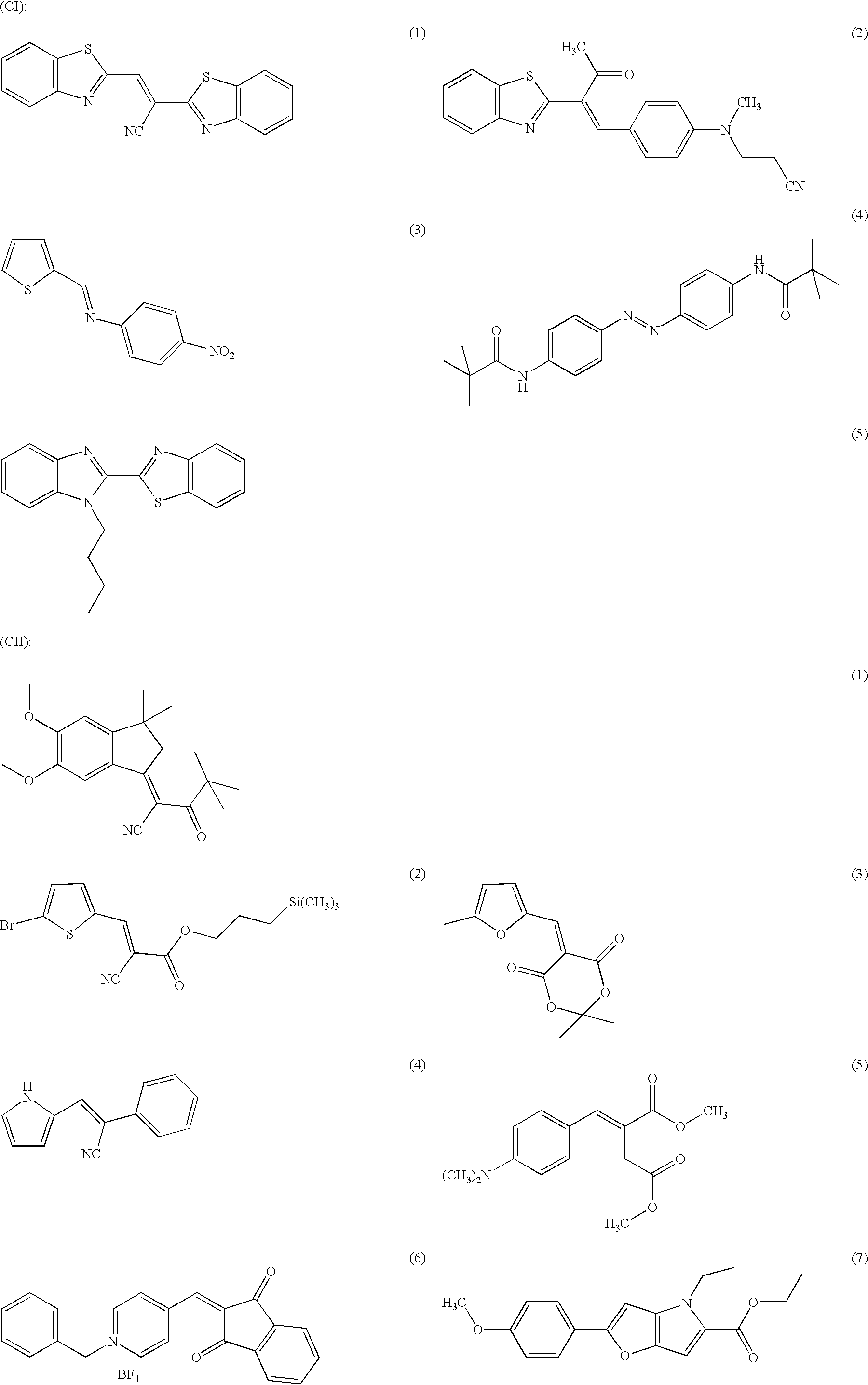

Preferred light-absorbent compounds having an absorption maximum λₘₐₓ₂ in the range from 400 to 650 nm are, for example, those of the following formulae:

Corresponding optical data stores comprising these compounds in the information layer can be read and written on by means of blue or red light, in particular blue or red laser light.

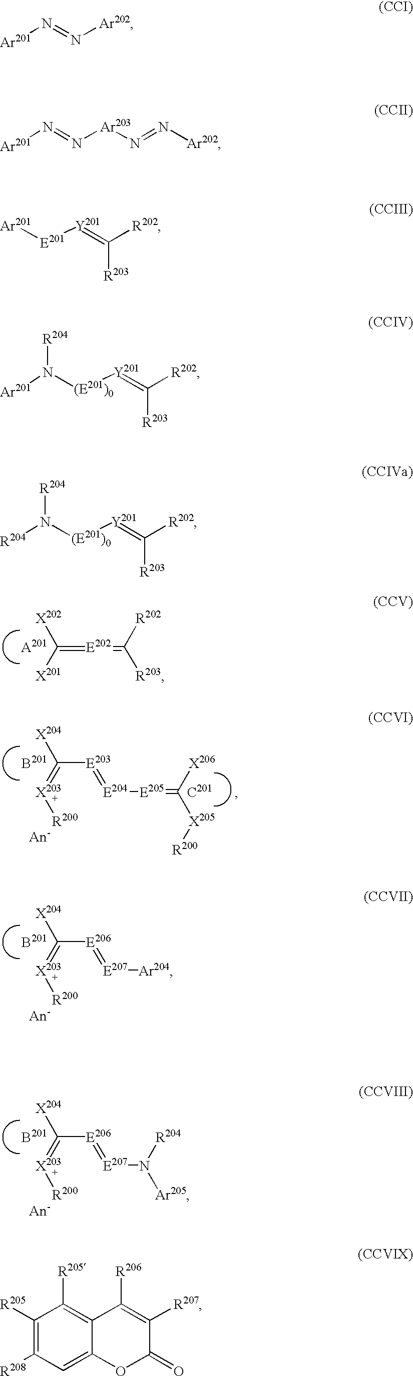

where

Ar²⁰¹, Ar²⁰², Ar²⁰⁴, Ar²⁰⁵ and Ar²⁰⁶ represent, independently of one another, C₆-C₁₀-aryl or the radical of a five- or six-membered aromatic, pseudoaromatic or partially hydrogenated heterocyclic ring, which may be benzo- or naphtho-fused and/or be substituted by nonionic radicals or sulpho,

Ar²⁰³ represents the bifunctional radical of a C₆-C₁₀-aromatic or the bifunctional radical of a five- or six-membered aromatic, pseudoaromatic or partially hydrogenated heterocyclic ring, which may be benzo- or naphtho-fused and/or be substituted by nonionic radicals or sulpho, where two such bifunctional radicals may be joined via a bifunctional bridge,

Y²⁰¹ represents N or C—R²⁰¹,

R²⁰¹ represents hydrogen, C₁-C₁₆-alkyl, cyano, carboxyl, C₁-C₁₆-alkoxycarbonyl, C₁-C₁₆-alkanoyl or Ar²⁰² or a bridge to Ar²⁰¹ or R²⁰⁰,

R²⁰² and R²⁰³ represent, independently of one another, cyano, carboxyl, C₁-C₁₆-alkoxycarbonyl, aminocarbonyl or C₁-C₁₆-alkanoyl or R²⁰² represents hydrogen, halogen or a radical of the formula

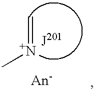

R²⁰³ represents Ar²⁰², CH₂—COOalkyl or P(O)(O—C₁-C₁₂-alkyl)₂ or C₁-C₁₆-alkyl or R²⁰²; R²⁰³ together with the carbon atom connecting them represent a five- or six-membered carbocyclic or aromatic, pseudoaromatic or partially hydrogenated heterocyclic ring which may be benzo- or naphtho-fused and/or be substituted by nonionic radicals,

E²⁰¹ represents a direct bond, —CH═CH—, —CH═C(CN)— or —C(CN)═C(CN)—,

o represents 1 or 2,

R²⁰⁴ represents hydrogen, C₁-C₁₆-alkyl or C₇-C₁₆-aralkyl or a bridge to Ar²⁰¹ or Ar²⁰² or E²⁰¹ or Ar²⁰⁵ or E²⁰⁷ or

NR²⁰⁴R²⁰⁴ represents pyrrolidino, piperidino or morpholino,

X²⁰¹, X²⁰², X²⁰⁴ and X²⁶ represent, independently of one another, O, S or N—R²⁰⁰, and X²⁰², X²⁰⁴ and X²⁰⁶ may also be CH or CR²⁰⁰R²⁰⁰,

A²⁰¹, B²⁰¹, C²⁰¹ and J²⁰¹ represent, independently of one another, a five- or six-membered aromatic, pseudoaromatic or partially hydrogenated heterocyclic ring which may be benzo- or naphtho-fused and/or be substituted by nonionic radicals,

X²⁰³ and X²⁰⁵ represent, independently of one another, N,

R²⁰⁰ represents hydrogen, C₁-C₁₆-alkyl or C₇-C₁₆-aralkyl or forms a ring to E²⁰², E²⁰³, E²⁰⁵ or E²⁰⁶,

E²⁰² represents a direct double bond, ═CH—CH═, ═N—CH═ or ═N—N═,

E²⁰³, E²⁰⁴, E²⁰⁵, E²⁰⁶ and E²⁰⁷ represent, independently of one another, N or C—R²⁰¹, —E²⁰³═E²⁰⁴— or —E²⁰⁶═E²⁰⁷ may represent a direct bond and two radicals R²⁰¹ may together form a two-, three- or four-membered bridge which may contain heteroatoms and/or be substituted by nonionic radicals and/or be benzo-fused,

R²⁰⁵ and R^{205′} represent hydrogen or together represent a —CH═CH—CH═CH— bridge,

R²⁰⁶ represents hydrogen, cyano or C₁-C₄-alkyl-SO₂—,

R²⁰⁷ represents hydrogen, cyano, C₁-C₄-alkoxycarbonyl or Ar²⁰¹,

R²⁰⁸ represents NR²²²R²²¹, piperidino, morpholino or pyrrolidino,

R²¹³, R²¹⁸, R²¹⁹, R²²² and R²²³ represent, independently of one another, hydrogen, C₁-C₁₆-alkyl, C₇-C₁₆-aralkyl or C₆-C₁₀-aryl,

X²⁰⁷ represents O, S, N—R²²² or C(CH₃)₂,

Y²⁰² and Y²⁰⁴ represent, independently of one another, OR²²², SR²²² or NR²²²R²²³,

Y²⁰³ and Y²⁰⁵ represent, independently of one another, O, S or N⁺R²²²R²²³ An⁻,

An⁻ represents an anion,

R²⁰⁹ and R²¹⁰ represent, independently of one another, hydrogen, C₁-C₄-alkyl, C₁-C₄-alkoxy, halogen, Y²⁰² or Y²⁰⁴ or together with R²¹⁶ and/or R²¹⁷ form a bridge or two adjacent radicals R²⁰⁹ or R²¹⁰ form a —CH═CH—CH═CH— bridge,

h and i represent, independently of one another, an integer from 0 to 3,

R²¹¹ represents hydrogen, C₁-C₄-alkyl or Ar²⁰¹,

Y²¹⁰ and Y²¹¹ represent, independently of one another, O, S or N—CN,

X²⁰8 and X²⁰⁹ represent, independently of one another, O, S or N—R²¹³,

R²¹² represents hydrogen, halogen, C₁-C₁₆-allyl, C₇-C₁₆-aralkyl or C₆-C₁₀-aryl,

R²¹⁴ and R²¹⁵ represent, independently of one another, hydrogen, C₁-C₈-alkyl, C₁-C₈-alkoxy, halogen, cyano, nitro or NR²²²R²²³ or two adjacent radicals R²¹⁴ or R²¹⁵ form a —CH═CH—CH═CH— bridge which may in turn be substituted by R²¹⁴ or R²¹⁵, where at least one of the radicals R²¹⁴ or R²¹⁵ represents NR²²²R²²³,

j and m represent, independently of one another, an integer from 1 to 4,

D²⁰¹, E²⁰¹, G²⁰¹ and H²⁰¹ represent, independently of one another, a five- or six-membered aromatic or pseudoaromatic carbocyclic ring or an aromatic, pseudoaromatic or partially hydrogenated heterocyclic ring, which may be benzo- or naphtho-fused and/or be substituted by nonionic radicals or sulpho,

Y²⁰⁶ and Y²⁰⁷ represent, independently of one another, —O—, —NR²²⁴—, —CO—O—, —CO—NR²²⁴, —SO₂—O— or SO₂—NR²²⁴—,

Y²⁰⁸, Y²⁰⁹ and Y²¹⁰ represent, independently of one another, N or CH,

Y²¹¹ represents O or —NR²²⁴,

R²²⁴ represents hydrogen, C₁-C₁₆-alkyl, cyano, C₁-C₁₆-alkoxycarbonyl, C₁-C₁₆-alkanoyl, C₁-C₁₆-alkylsulphonyl, C₆-C₁₀-aryl, C₆-C₁₀-arylcarbonyl or C₆-C₁₀-arylsulphonyl,

M²⁰⁰ and M²⁰¹ represent, independently of one another, an at least divalent metal ion which may bear further substituents and/or ligands, and M²⁰¹ may also represent two hydrogen atoms,

F²⁰¹ represents a five- or six-membered aromatic, pseudoaromatic or partially hydrogenated heterocyclic ring which may contain further heteroatoms and/or be benzo- or naphtho-fused and/or be substituted by nonionic radicals or sulpho,

R²²⁰ and R²²¹ represent, independently of one another, hydrogen, C₁-C₁₆-alkyl, C₁-C₁₆-alkoxy, cyano, C₁-C₁₆-alkoxycarbonyl, halogen, C₆-C₁₀-aryl, NR²¹¹R²²³ or together represent a bivalent radical of the formula

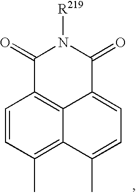

X²¹⁰ represents N, CH, C₁-C₆-alkyl, C—Ar²⁰¹, C—Cl or C—N(C₁-C₆-alkyl)₂,

Y²¹² represents N—R²⁰⁴, N—Ar²⁰¹, N—N═CH—Ar²⁰¹, CR²⁰²R²⁰³ or CH—C—R²⁰²R²⁰³ An⁻,

Y²¹³ represents NH—R²⁰⁴, NH—Ar²⁰¹, NH—N═CH—Ar²⁰¹, C—R²⁰³ An⁻ or CH═CR²⁰²R²⁰³,

where bonding to the bridge B, the dendritic structure D or the spacer group S is via the radicals R²⁰⁰ to R²²⁴ or via the nonionic radicals by which Ar²⁰¹ to Ar²⁰⁵ and the rings A²⁰¹ to J²⁰¹ may be substituted. In this case, the radicals represent a direct bond.

Nonionic radicals are C₁-C₄-alkyl, C₁-C₄-alkoxy, halogen, cyano, nitro, C₁-C₄-alkoxycarbonyl, C₁-C₄-alkylthio, C₁-C₄-alkanoylamino, benzoylamino, mono- or di-C₁-C₄-alkylamino.

Alkyl, alkoxy, aryl and heterocyclic radicals may, if desired, bear further radicals such as alkyl, halogen, nitro, cyano, COOH, CO—NH₂, alkoxy, trialkylsilyl, trialkylsiloxy, phenyl or SO₃H, the alkyl and alkoxy radicals may be straight-chain or branched, the alkyl radicals may be partially halogenated or perhalogenated, the alkyl and alkoxy radicals may be ethoxylated or propoxylated or silylated, adjacent alkyl and/or alkoxy radicals on aryl or heterocyclic radicals may together form a three- or four-membered bridge and the heterocyclic radicals may be benzo-fused and/or quaternized.

Particular preference is given to light-absorbent compounds of the formulae (CCI) to (CCXXVI) and (CCIVa),

where

Ar²⁰¹, Ar²⁰², Ar²⁰⁴, Ar²⁰⁵ and Ar²⁰⁶ represent, independently of one another, phenyl, naphthyl, benzothiazol-2-yl, benzoxazol-2-yl, benzimidazol-2-yl, thiazol-2- or -5-yl, thiazolin-2-yl, pyrrolin-2-yl, isothiazol-3-yl, imidazol-2-yl, 1,3,4-thiadiazol-2-yl, 1,3,4-triazol-2-yl, 2- or 4-pyridyl, 2- or 4-quinolyl, pyrrol-2- or -3-yl, thiophen-2- or -3-yl, furan-2- or -3-yl, indol-2- or -3-yl, benzothiophen-2-yl, benzofuran-2-yl or 3,3-dimethylindolen-2-yl, which may be substituted by methyl, ethyl, propyl, butyl, methoxy, ethoxy, propoxy, butoxy, hydroxy, chlorine, bromine, iodine, cyano, nitro, methoxycarbonyl, ethoxycarbonyl, methylthio, acetylamino, propionylamino, butanoylamino, benzoylamino, amino, dimethylamino, diethylamino, dipropylamino, dibutylamino, pyrrolidino, piperidino, morpholino, COOH or SO₃H,

Ar²⁰³ represents phenylene, naphthylene, 1,3,4-thiadiazol-2,5-diyl, 1,3,4-oxadiazol-2,5-diyl, 1,3,4-triazol-2,5-diyl or a bifunctional radical of the following formula

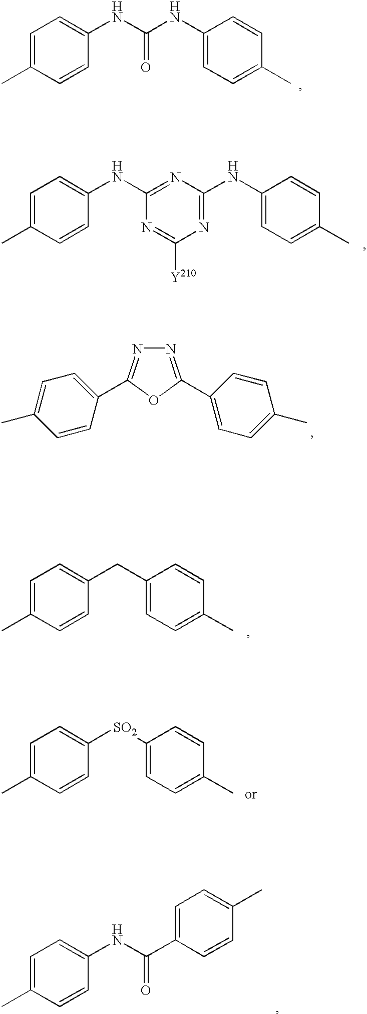

which may be substituted by chlorine, bromine, iodine, cyano, nitro, methoxycarbonyl, ethoxycarbonyl, methylthio, acetylamino, propionylamino, butanoylamino, benzoylamino, amino, dimethylamino, diethylamino, dipropylamino, dibutylamino, COOH or SO₃H,

Y²¹⁰ represents Cl, OH, NHR or NR²⁰⁰₂,

Y²⁰¹ represents N or C—R²⁰¹,

R²⁰¹ represents hydrogen, methyl, ethyl, propyl, butyl, cyano, carboxyl, methoxycarbonyl, ethoxycarbonyl, acetyl, propionyl or Ar²⁰²,

R²⁰² and R²⁰³ represent, independently of one another, cyano, carboxyl, methoxycarbonyl, ethoxycarbonyl, propoxycarbonyl, butoxycarbonyl, methoxyethoxycarbonyl, acetyl, propionyl or butanoyl or R²⁰² represents hydrogen or a radical of the formula

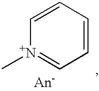

or R²⁰³ represents Ar²⁰² or R²⁰²; R²⁰³ together with the carbon atom connecting them represent a ring of the formula

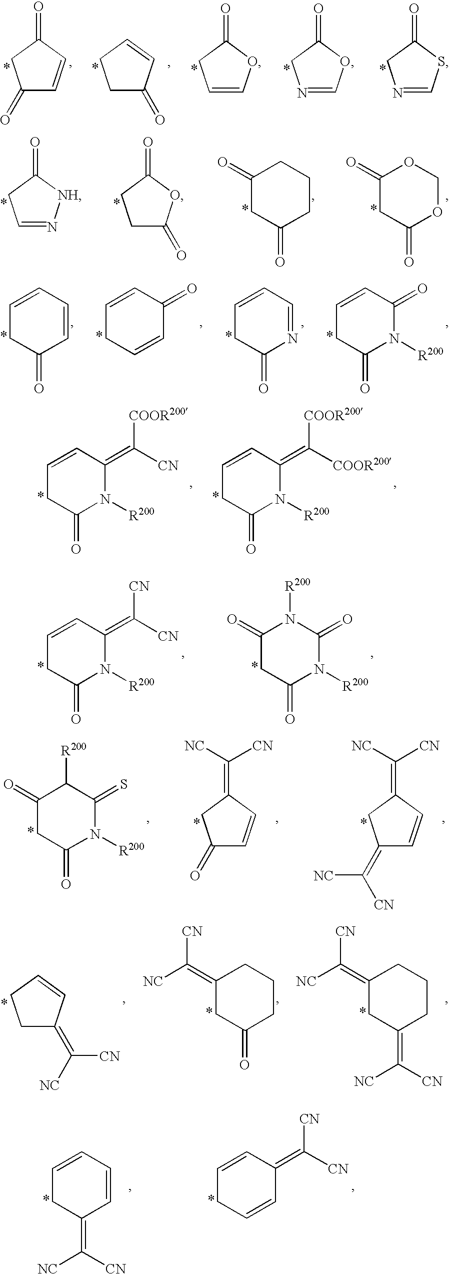

which may be benzo- or naphtho-fused and/or be substituted by nonionic or ionic radicals, where the asterisk (*) indicates the ring atom from which the double bond extends,

E²⁰¹ represents a direct bond or —CH═CH—,

R²⁰⁴ represents hydrogen, methyl, ethyl, propyl, butyl, benzyl or

Ar²⁰¹—N—R²⁰⁴ or Ar²⁰⁵—N—R²⁰⁴ represents an N-bonded pyrrole, indole or carbazole ring which may be substituted by methyl, ethyl, methoxy, ethoxy, propoxy, chlorine, bromine, iodine, cyano, nitro or methoxycarbonyl or

NR²⁰⁴R²⁰⁴ represents pyrrolidino, piperidino or morpholino,

A²⁰¹ represents benzothiazol-2-ylidene, benzoxazol-2-ylidene, benzimidazol-2-ylidene, thiazol-2-ylidene, thiazolin-2-ylidene, pyrrolin-2-ylidene, isothiazol-3-ylidene, imidazol-2-ylidene, 1,3,4-thiadiazol-2-ylidene, 1,3,4-triazol-2-ylidene, pyridin-2- or 4-ylidene, quinolin-2- or 4-ylidene, pyrrol-2- or -3-ylidene, thiophen-2- or -3-ylidene, furan-2- or -3-ylidene, indol-2- or -3-ylidene, benzothiophen-2-ylidene, benzofuran-2-ylidene, 1,3-dithiol-2-ylidene, benzo-1,3-dithiol-2-ylidene or 3,3-dimethylindolen-2-ylidene, which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, dimethylamino, diethylamino, dipropylamino, dibutylamino, methylbenzylamino, methylphenylamino, pyrrolidino or morpholino,

B²⁰¹ represents benzothiazol-2-yl, benzoxazol-2-yl, benzimidazol-2-yl, thiazol-2-yl, thiazolin-2-yl, pyrrolin-2-yl, isothiazol-3-yl, imidazol-2-yl, 1,3,4-thiadiazol-2-yl, 1,3,4-triazol-2-yl, 2- or 4-pyridyl, 2- or 4-quinolyl, indol-3-yl or 3,3-dimethylindolen-2-yl, which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, dimethylamino, diethylamino, dipropylamino, dibutylamino, methylbenzylamino, methylphenylamino, pyrrolidino or morpholino,

C²⁰¹ represents benzothiazol-2-ylidene, benzoxazol-2-ylidene, benzimidazol -2-ylidene, thiazol-2-ylidene, thiazol-5-ylidene, thiazolin-2-ylidene, pyrrolin-2-ylidene, isothiazol-3-ylidene, imidazol-2-ylidene, 1,3,4-thiadiazol-2-ylidene, 1,3,4-triazol-2-ylidene, pyridin-2- or 4-ylidene, quinolin-2- or 4-ylidene, indol-3-yl or 3,3-dimethylindolen-2-ylidene, which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, dimethylamino, diethylamino, dipropylamino, dibutylamino, methylbenzylamino, methylphenylamino, pyrrolidino, piperidino or morpholino, where

X²⁰¹, X²⁰², X²⁰⁴ and X²⁰⁶ represent, independently of one another, O, S or N—R²⁰⁰, and X²⁰², X²⁰⁴ and X²⁰⁶ may also represent CR²⁰⁰R²⁰⁰,

X²⁰³ and X²⁰⁵ represent, independently of one another, N, and

An⁻ represents an anion,

R²⁰⁰ represents hydrogen, methyl, ethyl, propyl, butyl or benzyl,

R^{200′} represents methyl, ethyl, propyl, butyl or benzyl,

E²⁰² represents ═CH—CH═, ═N—CH═ or ═N—N═,

—E²⁰³═E²⁰⁴—E²⁰⁵═ represents —CR^{201′}═CR^{201′}—CR^{201′}═, —N═N—N═, —N═CR^{201′}—CR^{201′}═, —CR^{201′}═N—CR^{201′}═, —CR^{201′}═CR^{201′}—N═, —N═N—CR^{201′}═ or —CR^{201′}═N—N═,

E²⁰⁶═E²⁰⁷ represents CR^{201′}═CR^{201′}, N═N, N═CR^{201′}, CR^{201′}═N or a direct bond,

R^{201′} represents hydrogen, methyl or cyano or two radicals R^{201′} represent a —CH₂—CH₂—, —CH₂—CH₂—CH₂— or —CH═CH—CH═CH— bridge,

R²⁰⁵ and R^{205′} represent hydrogen or together represent a —CH═CH—CH═CH— bridge,

R²⁰⁶ represents cyano or methyl-SO₂—,

R²⁰⁷ represents hydrogen, cyano, C₁-C₄-alkoxycarbonyl or Ar²⁰¹,

R²⁰⁸ represents NR²²²R²²³, piperidino, morpholino or pyrrolidino,

R²¹³, R²¹⁸, R²¹⁹, R²²² and R²²³ represent, independently of one another, hydrogen, methyl, ethyl, propyl, butyl, pentyl, hexyl, benzyl, phenethyl, phenylpropyl or phenyl, which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, COOH or SO₃H,

X²⁰⁷ represents O, S or N—R²²²,

Y²⁰² and Y²⁰⁴ represent, independently of one another, NR²²²R²²³,

Y²⁰³ and Y²⁰⁵ represent, independently of one another, O or N⁺R²²²R²²³ An⁻,

R²⁰⁹ and R²¹⁰ represent, independently of one another, hydrogen, methyl, ethyl, methoxy, ethoxy, chlorine or bromine or R²⁰⁹; R²²², R²⁰⁹; R²²³, R²¹⁰; R²²² and/or R²¹⁰; R²²³ form a —CH₂—CH₂— or —CH₂—CH₂—CH₂-bridge or two adjacent radicals R²⁰⁹ or R²¹⁰ form a —CH═CH—CH═CH-bridge,

a and b represent, independently of one another, an integer from 0 to 3,

R²¹¹ represents hydrogen, methyl, ethyl, propyl, butyl, pentyl, hexyl or phenyl, which may be substituted by from 1 to 3 radicals selected from the group consisting of hydroxy, methyl, methoxy, chlorine, bromine, COOH, methoxycarbonyl, ethoxycarbonyl or SO₃H,

Y²¹⁰ and Y²¹¹ represent, independently of one another, O or N—CN,

X²⁰⁸ and X²⁰⁹ represent, independently of one another, O or N—R²¹³,

R²¹² represents hydrogen or chlorine,

R²¹⁴ and R²¹⁵ represent, independently of one another, hydrogen, methyl, ethyl, propyl, butyl, methoxy, ethoxy, propoxy, butoxy, chlorine, bromine, cyano, nitro or NR²²²R²²³ or two adjacent radicals R²¹⁴ and R²¹⁵ may form a —CH═CH—CH═CH— bridge, where at least one, preferably two, of the radicals R²¹⁴ or R²¹⁵ represent NR²²²R²²³,

d and e represent, independently of one another, an integer from 1 to 3,

D²⁰¹ and E²⁰¹ represent, independently of one another, phenyl, naphthyl, pyrrole, indole, pyridine, quinoline, pyrazole or pyrimidine, which may be substituted by methyl, ethyl, propyl, butyl, methoxy, ethoxy, propoxy, butoxy, chlorine, bromine, cyano, nitro, hydroxy, NR²²²R²²³, acetylamino, propionylamino or benzoylamino,

Y²⁰⁶ and Y²⁰⁷ represent, independently of one another, —O—, —NR²²⁴—, —CO—O— or —CO—NR²²⁴—,

Y²⁰⁸═Y²⁰⁹ represents N═N or CH═N,

Y²¹⁰ represents N or CH,

R²²⁴ represents hydrogen, methyl, formyl, acetyl, propionyl, methylsulphonyl or ethylsulphonyl,

M²⁰⁰ represents Cu, Fe, Co, Ni, Mn or Zn,

M²⁰¹ represents 2 H atoms, Cu^{II}, Co^{II}, Co^{III}, Ni^{II}, Zn, Mg, Cr, Al, Ca, Ba, In, Be, Cd, Pb, Ru, Be, Pd^{II}, Pt^{II}, Al, Fe^{II}, Fe^{II}, Mn^{II}, V^{IV}, Ge, Sn, Ti or Si, where in the case of M²⁰¹ being Co^{III}, Fe^{II}, Fe^{III}, Al, In, Ge, Ti, V^{IV} and Si it bears one or two further substituents or ligands R²²⁵ and/or R²²⁶ which are arranged axially relative to the plane of the porphyrin ring,

R²²⁵ and R²²⁶ represent, independently of one another, methyl, ethyl, phenyl, hydroxy, fluorine, chlorine, bromine, methoxy, ethoxy, phenoxy, tolyloxy, cyano or ═O,

F²⁰¹ represents pyrrol-2-yl, imidazol-2- or 4-yl, pyrrazol-3- or -5-yl, 1,3,4-triazol-2-yl, thiazol-2- or -4-yl, thiazolin-2-yl, pyrrolin-2-yl, oxazol-2- or -4-yl, isothiazol-3-yl, isoxazol-3-yl, indol-2-yl, benzimidazol-2-yl, benzothiazol-2-yl, benzoxazol-2-yl, benzoisothiazol-3-yl, 1,3,4-thiadiazol-2-yl, 1,2,4-thiadiazol-3- or -5-yl, 1,3,4-oxadiazol-2-yl, pyrid-2-yl, quinol-2-yl, which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino, benzoylamino, dimethylamino, diethylamino, dipropylamino, diethylamino, dicyclohexylamino, anilino, N-methylanilino, diethanolamino, N-methylethanolamino, pyrrolidino, morpholino or piperidino,

G²⁰¹ represents a ring of the formula

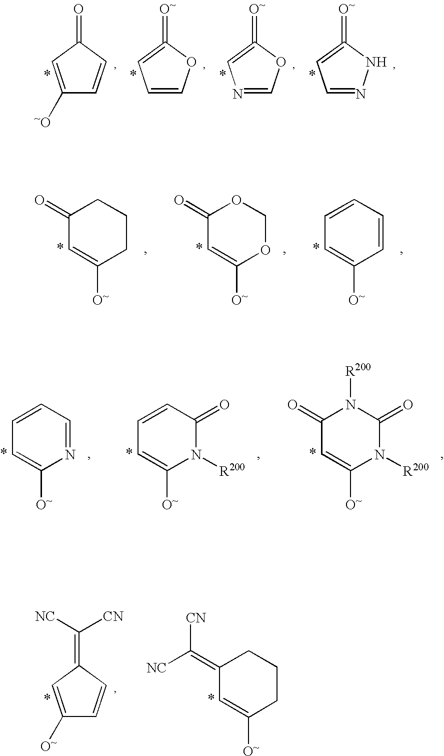

which may be benzo- or naphtho-fused and/or be substituted by nonionic radicals, where the asterisk (*) indicates the ring atom from which the single bond to Y²¹⁰ extends and the squiggle (˜) indicates the oxygen atom (═Y²⁰⁶) from which the single bond to M extends, and

Y²⁰⁶ represents —O—,

H²⁰¹ represents a ring of the formula

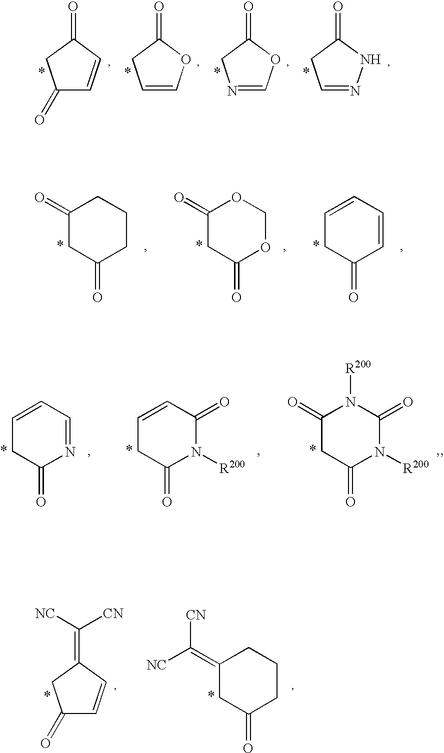

which may be benzo- or naphtho-fused and/or be substituted by nonionic radicals, where the asterisk (*) indicates the ring atom from which the double bond to Y²¹⁰ extends, and

Y²¹¹ represents ═O,

E²⁰¹ represents a direct bond,

R²⁰⁴ represents hydrogen, methyl, ethyl, propyl, butyl, benzyl or

Ar²⁰¹—N—R²⁰⁴ or Ar²⁰⁵—N—R²⁰⁴ represents an N-bonded pyrrole, indole or carbazole ring which may be substituted by methyl, ethyl, methoxy, ethoxy, propoxy, chlorine, bromine, iodine, cyano, nitro or methoxycarbonyl,

R²²⁰ and R²¹ represent, independently of one another, hydrogen, methoxy, ethoxy, propoxy, butoxy, cyano, methoxycarbonyl, chlorine, bromine, phenyl, dimethylamino, diethylamino, dipropylamino, dibutylamino, anilino or together represent a bivalent radical of the formula

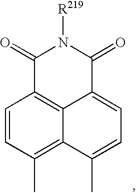

X²⁰¹ represents N or CH,

Y²¹² represents N—R²⁰⁴, N—Ar²⁰¹ or CR²⁰²R²⁰³,

Y²¹³ represents NH—R²⁰⁴, NH—Ar²⁰¹ or CR²⁰²R²⁰³ An⁻,

where bonding to the bridge B, the dendritic structure D or the spacer group S is via the radicals R²⁰⁰ to R²²⁴ or via the nonionic radicals by which Ar²⁰¹ to Ar²⁰⁵ and the rings A²⁰¹ to H²⁰¹ may be substituted. In this case, these radicals represent a direct bond.

The following examples serve to illustrate:

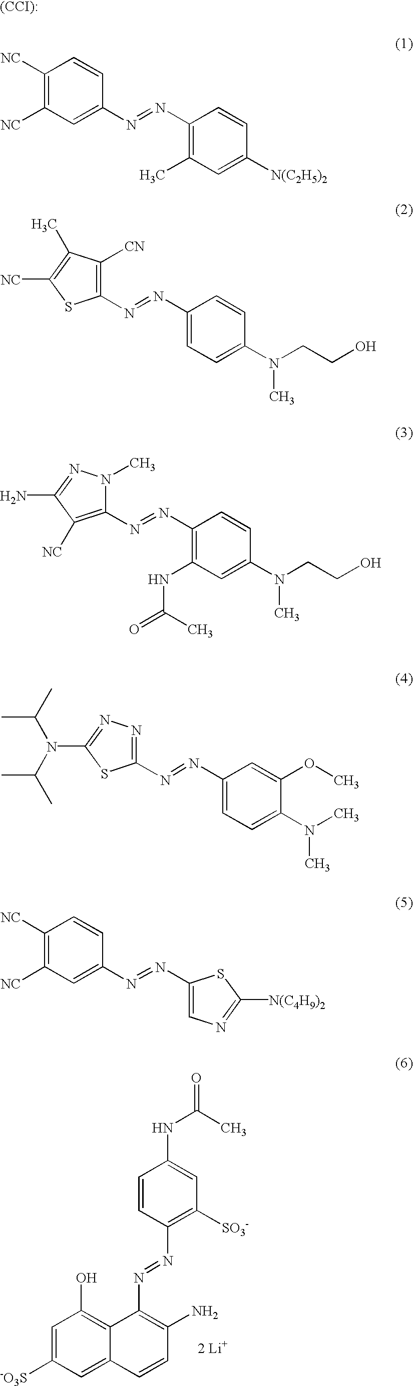

Preferred light-absorbent compounds having an absorption maximum λₘₐₓ₃ in the range from 630 to 820 nm are those of the following formulae:

Corresponding optical data stores comprising these compounds in the information layer can be read and written on by means of red or infrared light, in particular red or infrared laser light.

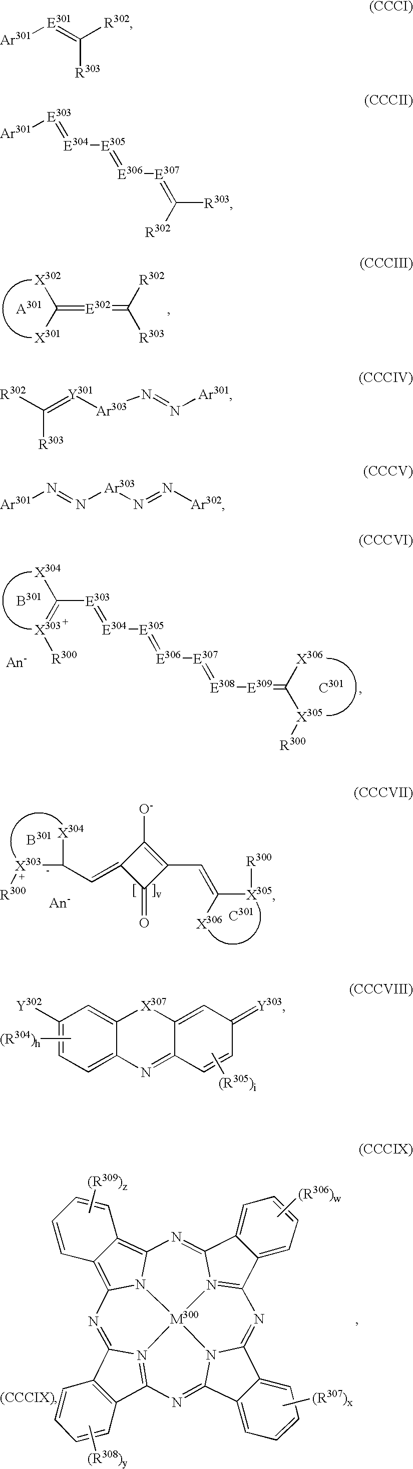

where

Ar³⁰¹ and Ar³⁰² represent, independently of one another, C₆-C₁₀-aryl or the radical of a five- or six-membered aromatic, pseudoaromatic or partially hydrogenated heterocyclic ring, which may be benzo- or naphtho-fused and/or be substituted by nonionic radicals or sulpho,

Ar³⁰³ represents the bifunctional radical of a C₆-C₁₀-aromatic or the bifunctional radical of a five- or six-membered aromatic, pseudoaromatic or partially hydrogenated heterocyclic ring, which may be benzo- or naphtho-fused and/or be substituted by nonionic radicals or sulpho, where two such bifunctional radicals may be connected via a bifunctional bridge,

E³⁰¹ represents N, C—Ar³⁰² or N⁺—Ar³⁰² An⁻,

An⁻ represents an anion,

R³⁰² and R³⁰³ represent, independently of one another, cyano, carboxyl, C₁-C₁₆-alkoxycarbonyl, aminocarbonyl or C₁-C₁₆-alkanoyl or R³⁰³ represents Ar³⁰² or R³⁰²; R³⁰³ together with the carbon atom connecting them represent a five- or six-membered carbocyclic or aromatic, pseudoaromatic or partially hydrogenated heterocyclic ring which may be benzo- or naphtho-fused and/or be substituted by nonionic or ionic radicals,

E³⁰³ to E³⁰⁹ represent, independently of one another, C—R³¹⁰ or N, where the radicals R³¹⁰ of two elements E³⁰³ to E³⁰⁹ may together form a 2- to 4-membered bridge which may contain heteroatoms and/or be substituted by nonionic radicals and/or be benzo-fused, and E³⁰⁵—E³⁰⁶ and/or E³⁰⁷—E³⁰⁸ may represent a direct bond,

R³¹⁰ represents hydrogen, C₁-C₁₆-alkyl, cyano, carboxyl, C₁-C₁₆-alkoxycarbonyl, C₁-C₁₆-alkanoyl, Ar³⁰², —CH═CH—Ar³⁰², —(CH═CH)₂—Ar³⁰² or a radical of the formula

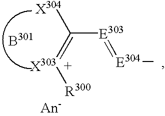

X³⁰¹, X³⁰², X³⁰⁴ and X³⁰⁶ represent, independently of one another, O, S or N—R³⁰⁰, and X³⁰², X³⁰⁴ and X³⁰⁶ may also represent CR³⁰⁰OOR³⁰⁰,

A³⁰¹, B³⁰¹ and C³⁰¹ represent, independently of one another, a five- or six-membered aromatic, pseudoaromatic or partially hydrogenated heterocyclic ring which may be benzo- or naphtho-fused and/or be substituted by nonionic radicals,

X³⁰³ and X³⁰⁵ represent, independently of one another, N, or (X³⁰³)⁺—R³⁰⁰ represents O⁺ or S⁺ and/or X³⁰⁵—R³⁰⁰ represents O or S,

R³⁰⁰ represents hydrogen, C₁-C₁₆-alkyl or C₇-C₁₆-aralkyl or forms a ring to E³⁰², E³⁰³ or E³⁰⁷,

E³⁰² represents ═CH═CH—, ═N—CH═, ═N—N═ or a bivalent radical of the formula

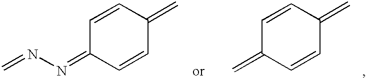

where the six-membered ring may be substituted by nonionic radicals and/or be benzo-fused,

Y³⁰¹ represents N or C—R³⁰¹,

R³⁰¹ represents hydrogen, C₁-C₁₆-alkyl, cyano, carboxyl, C₁-C₁₆-alkoxycarbonyl, C₁-C₁₆-alkanoyl or Ar³⁰² or a bridge to R³⁰² or Ar³⁰³,

v represents 1 or 2,

X³⁰⁷ represents O, S or N—R³¹¹,

R³¹¹ and R³¹² represent, independently of one another, hydrogen, C₁-C₁₆-alkyl, C₇-C₁₆-aralkyl or C₆-C₁₀-aryl,

Y³⁰² represents NR³¹¹R³¹²,

Y³⁰³ represents CR³⁰²R³⁰³,

R³⁰⁴ and R³⁰⁵ represent, independently of one another, hydrogen, C₁-C₁₆-alkyl, C₁-C₁₆-alkoxy, C₆-C₁₀-aryloxy or two adjacent radicals R³⁰⁴ or R³⁰⁵ represent a —CH═CH—CH═CH— bridge,

h and i represent, independently of one another, an integer from 0 to 3,

M³⁰⁰ represents 2 H atoms or an at least divalent metal or nonmetal, where M may bear further, preferably 2, substituents or ligands R³¹³ and/or R³¹⁴,

R³⁰⁶ to R³⁰⁹ represent, independently of one another, C₁-C₁₆-alkyl, C₁-C₁₆-alkoxy, C₁-C₁₆-alkylthio, C₆-C₁₀-aryloxy, halogen, COOH, —CO—OR³¹¹, —CO—NR³¹¹R³¹², —SO₃H, —SO₂—NR³¹¹R³¹² or two adjacent radicals R³⁰⁶, R³⁰⁷, R³⁰⁸ or R³⁰⁹ represent a —CH═CH—CH═CH— bridge,

w to z represent, independently of one another, an integer from 0 to 4, where, if w, x, y or z>1, R³⁰⁶, R³⁰⁷, R³⁰⁸ or R³⁰⁹ may have different meanings,

R³¹³ and R³¹⁴ represent, independently of one another, C₁-C₁₆-alkoxy, C₆-C₁₀-aryloxy, hydroxy, halogen, cyano, thiocyanato, C₁-C₁₂-alkylisonitrilo, C₆-C₁₀-aryl, C₁-C₁₆-alkyl, C₁-C₁₂-alkyl-CO—O—, C₁-C₁₂-alkyl-SO₂—O—, C₆-C₁₀-aryl-CO—O—, C₆-C₁₀-aryl-SO₂—O, tri-C₁-C₁₂-alkylsiloxy or NR³¹¹R³¹²,

where bonding to the bridge B, the dendritic structure D or the spacer group S is via the radicals R³⁰⁰ to R³¹⁴ or via the nonionic radicals by which Ar³⁰¹ to Ar³⁰³ and the rings A³⁰¹ to C³⁰¹ may be substituted. In this case, these radicals represent a direct bond.

The phthalocyanines of the formula (CCCIX) also encompass the corresponding monoaza to tetraaza derivatives and their quaternary salts.

Nonionic radicals are, for example, C₁-C₄-alkyl, C₁-C₄-alkoxy, halogen, cyano, nitro, C₁-C₄-alkoxycarbonyl, C₁-C₄-alkylthio, C₁-C₄-alkanoylamino, benzoylamino, mono- or di-C₁-C₄-alkylamino.

Alkyl, alkoxy, aryl and heterocyclic radicals may, if desired, bear further radicals such as alkyl, halogen, nitro, cyano, COOH, CO—NH₂, alkoxy, trialkylsilyl, trialkylsiloxy, phenyl or SO₃H, the alkyl and alkoxy radicals may be straight-chain or branched, the alkyl radicals may be partially halogenated or perhalogenated, the alkyl and alkoxy radicals may be ethoxylated or propoxylated or silylated, adjacent alkyl and/or alkoxy radicals on aryl or heterocyclic radicals may together form a three- or four-membered bridge and the heterocyclic radicals may be benzo-fused and/or quaternized.

Particular preference is given to light-absorbent compounds of the formulae (CCCI) to (CCCIX),

where

Ar³⁰¹ and Ar³⁰² represent, independently of one another, phenyl, naphthyl, benzothiazol-2-yl, benzoxazol-2-yl, benzimidazol-2-yl, thiazol-2-yl, isothiazol-3-yl, imidazol-2-yl, 1,3,4-thiadiazol-2-yl, 1,3,4-triazol-2-yl, 2- or 4-pyridyl, 2- or 4-quinolyl, pyrrol-2- or -3-yl, thiophen-2- or -3-yl, furan-2- or -3-yl, indol-2- or -3-yl, benzothiophen-2-yl, benzofuran-2-yl, 1,2-dithiol-3-yl or 3,3-dimethylindolen-2-yl, which may be substituted by methyl, ethyl, propyl, butyl, methoxy, ethoxy, propoxy, butoxy, hydroxy, chlorine, bromine, iodine, cyano, nitro, methoxycarbonyl, ethoxycarbonyl, methylthio, acetylamino, propionylamino, butanoylamino, benzoylamino, amino, dimethylamino, diethylamino, dipropylamino, dibutylamino, pyrrolidino, piperidino, morpholino, COOH or SO₃H, and Ar³⁰¹ may also represent a ring of the formula

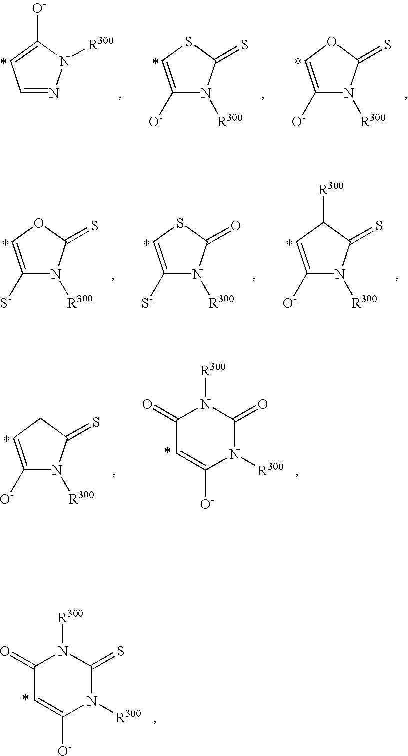

which may be benzo- or naphtho-fused and/or be substituted by nonionic radicals, where the asterisk (*) indicates the ring atom from which the single bond extends,

Ar³⁰³ represents phenylene, naphthylene, thiazol-2,5-diyl, thiophen-2,5-diyl or furan-2,5-diyl, which may be substituted by methyl, ethyl, propyl, butyl, methoxy, ethoxy, propoxy, butoxy, hydroxy, chlorine, bromine, iodine, cyano, nitro, methoxycarbonyl, ethoxycarbonyl, methylthio, acetylamino, propionylamino, butanoylamino or benzoylamino,

E³⁰¹ represents N, C—Ar³⁰² or N⁺—Ar³⁰² An⁻,

An⁻ represents an anion,

R³⁰² and R³⁰³ represent, independently of one another, cyano, carboxyl, methoxycarbonyl, ethoxycarbonyl, propoxycarbonyl, butoxycarbonyl, methoxyethoxycarbonyl, acetyl, propionyl or butanoyl, or R²⁰³ represents Ar³⁰² or R³⁰²; R³⁰³ together with the carbon atom connecting them represent a ring of the formula

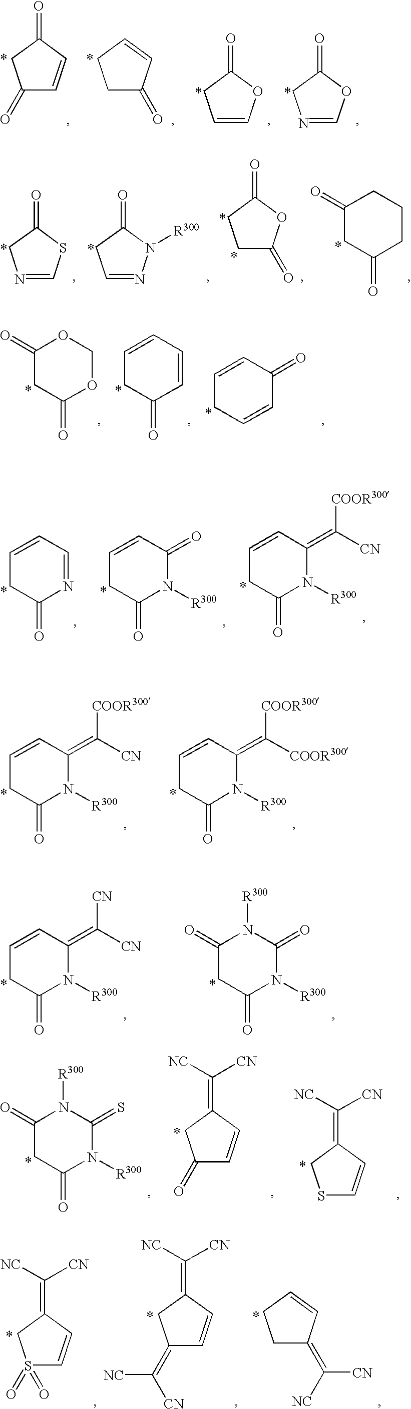

which may be benzo- or naphtho-fused and/or be substituted by nonionic or ionic radicals, where the asterisk (*) indicates the ring atom from which the double bond extends,

E³⁰³ to E³⁰⁹ represent, independently of one another, C—R³¹⁰ or N, where two adjacent elements E³³ to E³¹⁹ may represent a bivalent group of the formula

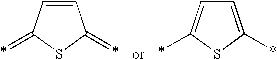

or three adjacent elements E³⁰³ to E³⁰⁹ may represent a bivalent group of the formula

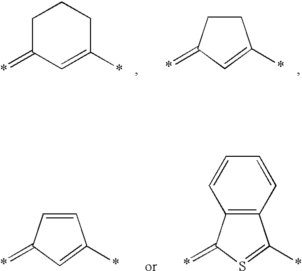

or five adjacent elements E³⁰³ to E³⁰⁹ may represent a bivalent group of the formula

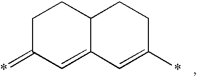

where in each case the asterisked (*) bonds represent single or double bonds to the next element E, to Ar³⁰¹, CR³⁰²R³⁰³ or to a ring B³⁰¹ or C³⁰¹ and the rings may be substituted by methyl, methoxy, chlorine, cyano or phenyl, and E³⁰⁵═E³⁰⁶ and/or E³⁰⁷═E³⁰⁸ may represent a direct bond,

R³¹⁰ represents hydrogen, methyl, ethyl, cyano, chlorine, phenyl or a radical of the formula

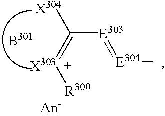

A³⁰¹ represents benzothiazol-2-ylidene, benzoxazol-2-ylidene, benzimidazol-2-ylidene, thiazol-2-ylidene, isothiazol-3-ylidene, imidazol-2-ylidene, 1,3,4-thiadiazol-2-ylidene, 1,3,4-triazol-2-ylidene, pyridin-2- or 4-ylidene, quinolin-2- or 4-ylidene, pyrrol-2- or -3-ylidene, thiophen-2- or -3-ylidene, furan-2- or -3-ylidene, indol-2- or -3-ylidene, benzothiophen-2-ylidene, benzofuran-2-ylidene, 1,3-dithiol-2-ylidene, benzo-1,3-dithiol-2-ylidene, 1,2-dithiol-3-ylidene or 3,3-dimethylindolen-2-ylidene, which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino or benzoylamino,

B³⁰¹ represents benzothiazol-2-yl, benzoxazol-2-yl, benzimidazol-2-yl, thiazol-2-yl, isothiazol-3-yl, imidazol-2-yl, 1,3,4-thiadiazol-2-yl, 1,3,4-triazol-2-yl, 2- or 4-pyridyl, 2- or 4-quinolyl, pyrrylium-2- or -4-yl, thiopyrrylium-2- or -4-yl, indol-3-yl, benz[c,d]indol-2-yl or 3,3-dimethylindolen-2-yl, which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino or benzoylamino,

C³⁰¹ represents benzothiazol-2-ylidene, benzoxazol-2-ylidene, benzimidazol-2-ylidene, thiazol-2-ylidene, isothiazol-3-ylidene, imidazol-2-ylidene, 1,3,4-thiadiazol-2-ylidene, 1,3,4-triazol-2-ylidene, pyridin-2- or 4-ylidene, quinolin-2- or 4-ylidene, dehydropyran-2- or -4-ylidene, thiopyran-2- or -4-ylidene, indol-3-yl, benz[c,d]indol-2-ylidene or 3,3-dimethylindolen-2-ylidene, which may be substituted by methyl, ethyl, propyl, butyl, methoxy, ethoxy, propoxy, butoxy, chlorine, bromine, iodine, cyano, nitro, methoxycarbonyl, ethoxycarbonyl, methylthio, acetylamino, propionylamino, butanoylamino or benzoylamino, where

X³⁰¹, X³⁰², X³⁰⁴ and X³⁰⁶ represent, independently of one another, O, S or N—R³⁰⁰ and X³⁰², X³⁴ and X³⁰⁶ may also be CR³⁰⁰R³⁰⁰,

X³⁰³ and X³⁰⁵ represent, independently of one another, N, or (X³⁰³)⁺—R³⁰⁰ represents O⁺ or S⁺ and/or X³⁰⁵—R³⁰⁰ represents O or S, and

An⁻ represents an anion,

R³⁰⁰ represents hydrogen, methyl, ethyl, propyl, butyl or benzyl,

R^{300′} represents methyl, ethyl, propyl, butyl or benzyl,

E³⁰² represents a bivalent radical of the formula

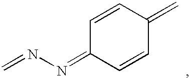

where the six-membered ring may be substituted by methyl, ethyl, methoxy, ethoxy, propoxy, butoxy, acetamino, propionylamino or methylsulphonylamino and/or be benzo-fused,

Y³⁰¹ represents N or C—R³⁰¹,

R³⁰¹ represents hydrogen, methyl, ethyl, cyano, carboxyl, methoxycarbonyl, ethoxycarbonyl, acetyl or propionyl,

v represents 1 or 2,

X³⁰⁷ represents O, S or N—R³¹¹,

R³¹¹ and R³¹² represent, independently of one another, hydrogen, methyl, ethyl, propyl, butyl, pentyl, hexyl, benzyl, phenyl, which may be substituted by one or more of the radicals methoxy, ethoxy, propoxy, chlorine, bromine, dimethylamino or diethylamino,

Y³⁰² represents NR³¹¹R³¹²,

Y³⁰³ represents CR³⁰²R³⁰³,

R³⁰⁴ and R³⁰⁵ represent, independently of one another, hydrogen, methyl, ethyl, propyl, butyl, methoxy, ethoxy or phenoxy or two adjacent radicals R³⁰⁴ or R³⁰⁵ represent a —CH═CH—CH═CH— bridge,

M³⁰⁰ represents 2 H atoms, Cu^{II}, Co^{II}, Co^{III}, Ni^{II}, Zn, Mg, Cr, Ca, Ba, In, Be, Cd, Pb, Ru, Be, Al, Pd^{II}, Pt^{II}, Al, Fe^{II}, Fe^{III}, Mn^{II}, V^{IV}, Ge, Sn, Ti or Si, where in the case of M being Co^{III}, Fe^{II}, Fe^{III}, Al, In, Ge, Ti, V^{IV} and Si it bears one or two further substituents or ligands R³¹³ and/or R³¹⁴ which are arranged axially relative to the plane of the phthalocyanine ring,

R³⁰⁶ to R³⁰⁹ represent, independently of one another, methyl, ethyl, propyl, butyl, pentyl, hexyl, methoxy, ethoxy, propoxy, butoxy, pentoxy, hexoxy, phenoxy, chlorine, bromine, —SO₃H or SO₂NR³¹¹R³¹² or two adjacent radicals R³⁰⁶, R³⁰⁷, R³⁰⁸ or R³⁰⁹ represent a —CH═CH—CH═CH— bridge,

w to z represent, independently of one another, an integer from 0 to 4, where, if w, x, y or Z>1, R³⁰⁶, R³⁰⁷, R³⁰⁸ or R³¹⁹ may have different meanings, R³¹³ and R³¹⁴ represent, independently of one another, hydroxy, fluorine, chlorine, bromine, cyano, ═O, methoxy, ethoxy, propoxy, butoxy, pentoxy, hexoxy, phenoxy, pyrazolo, imidazolo or NR³¹¹R³¹², which may be substituted by one or more of the radicals methoxy, ethoxy, propoxy, chlorine, bromine, dimethylamino or diethylamino,

where bonding to the bridge B, the dendritic structure D or the spacer group S is via the radicals R³⁰⁰ to R³¹⁴ or via the nonionic radicals by which Ar³⁰¹ to Ar³⁰³ and the rings A³⁰¹ to C³⁰¹ may be substituted. In this case, these radicals represent a direct bond.

The following examples serve to illustrate:

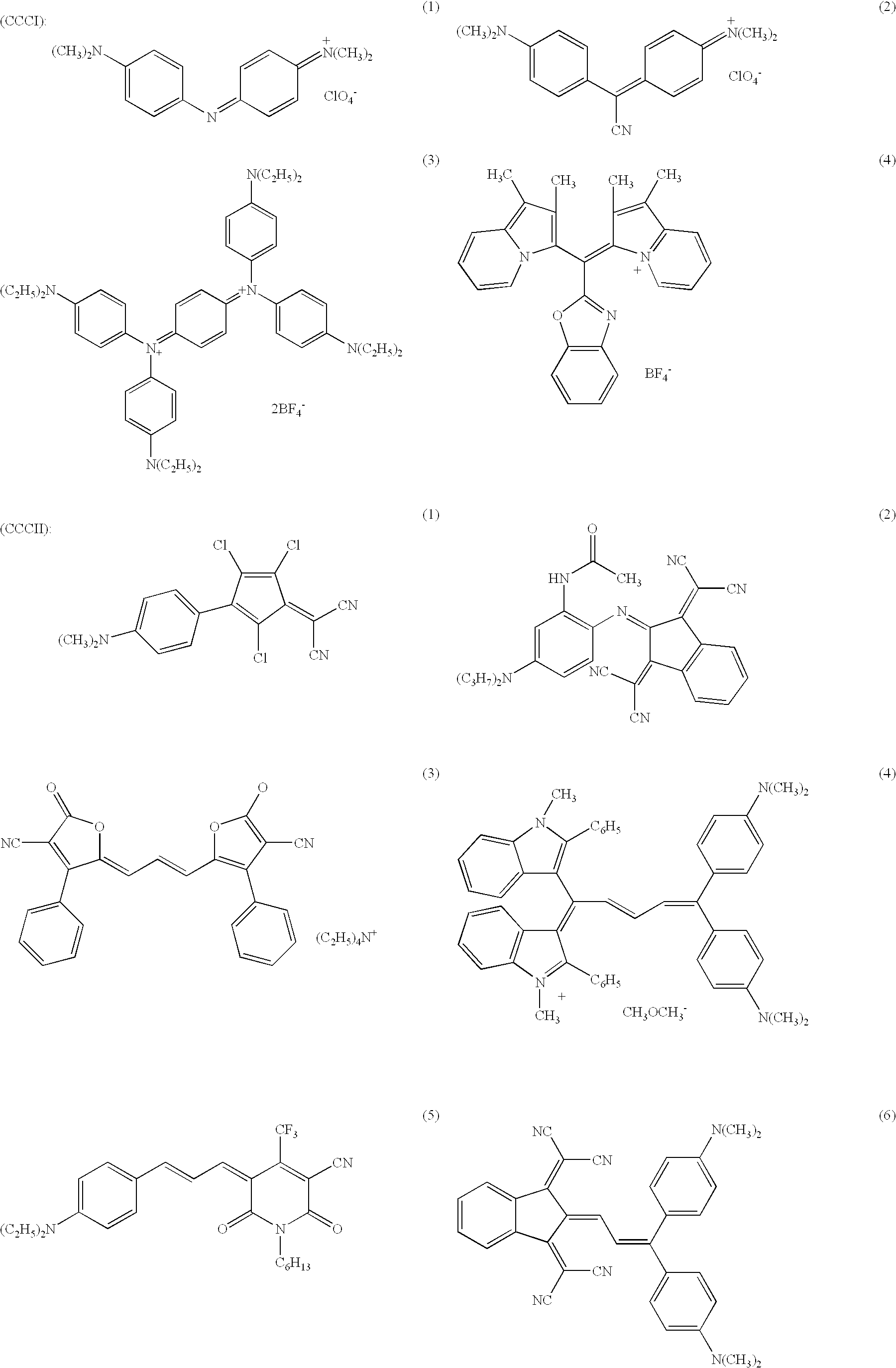

Examples of light-absorbent compounds which have at least two chromophoric centres as described above and are suitable for the optical data carrier of the invention are:

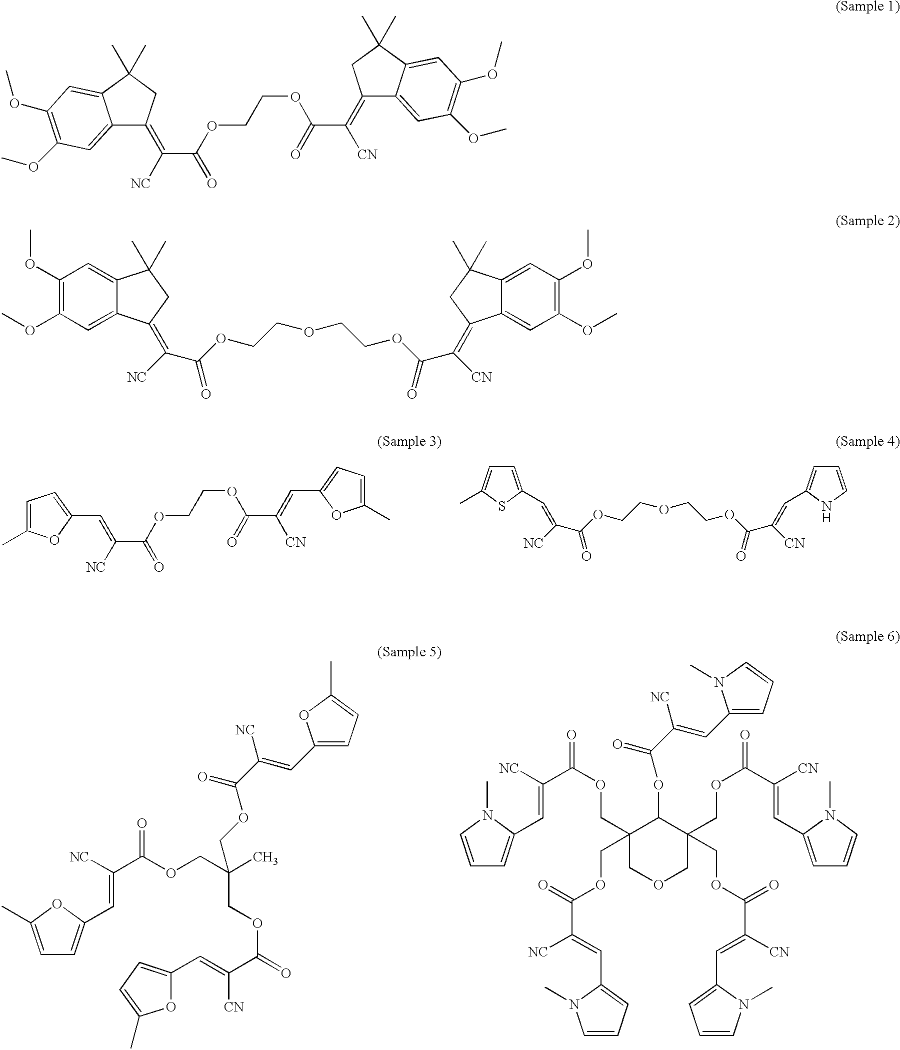

The absorption spectra are preferably measured in solution. The light-absorbent compounds described guarantee a sufficiently high reflectivity (>10%) of the optical data carrier in the unwritten state and a sufficiently high absorption for thermal degradation of the information layer on point-wise illumination with focused light if the wavelength of the light is in the range from 360 to 460 nm, from 600 to 680 nm or from 750 to 820 nm. The contrast between written and unwritten points on the data carrier is achieved by the reflectivity change of the amplitude and also the phase of the incident light due to the changed optical properties of the information layer after the thermal degradation.

The invention further provides a write-once optical data carrier comprising a preferably transparent substrate to whose surface at least one light-writeable information layer, if desired a reflection layer and/or if desired a protective layer have been applied, which can be written on or read by means of blue, red or infrared light, preferably laser light, where the information layer comprises at least one of the abovementioned light-absorbent compounds and, if desired, a binder, wetting agents, stabilizers, diluents and sensitizers and also further constituents. Alternatively, the structure of the optical data carrier may:

comprise a preferably transparent substrate to whose surface at least one light-writeable information layer, if desired a reflection layer and, if desired, an adhesive layer and a further preferably transparent substrate have been applied, or

comprise a preferably transparent substrate to whose surface if desired a reflection layer, at least one light-writeable information layer, if desired an adhesive layer and a transparent covering layer have been applied.

Apart from the information layer, further layers such as metal layers, dielectric layers and protective layers may be present in the optical data carrier. Metals and dielectric layers serve, inter alia, to adjust the reflectivity and the heat absorption/retention. Metals can be, depending on the laser wavelength, gold, silver, aluminium, etc. Examples of dielectric layers are silicon dioxide and silicon nitride. Protective layers are, for example, photocurable surface coatings, pressure-sensitive) adhesive layers and protective films.

Pressure-sensitive adhesive layers consist mainly of acrylic adhesives. Nitto Denko DA-8320 or DA-8310, disclosed in the patent JP-A 11-2731471, can, for example, be used for this purpose.

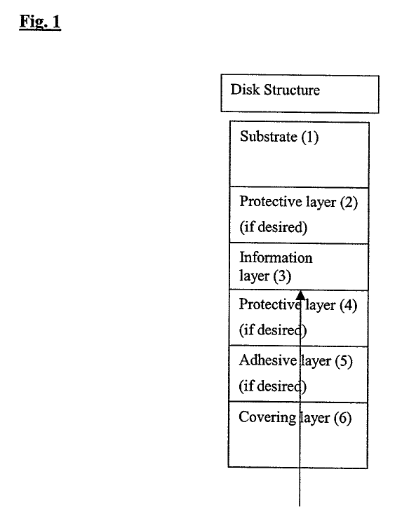

The optical data carrier has, for example, the following layer structure (cf. FIG. 1): a transparent substrate (1), if desired a protective layer (2), an information layer (3), if desired a protective layer (4), if desired an adhesive layer (5), a covering layer (6).

The structure of the optical data carrier preferably:

comprises a preferably transparent substrate (1) to whose surface at least one light-writeable information layer (3) which can be written on by means of light, preferably laser light, if desired a protective layer (4), if desired an adhesive layer (5) and a transparent covering layer (6) have been applied.

comprises a preferably transparent substrate (1) to whose surface a protective layer (2), at least one information layer (3) which can be written on by means of light, preferably laser light, if desired an adhesive layer (5) and a transparent covering layer (6) have been applied.

comprises a preferably transparent substrate (1) to whose surface a protective layer (2) if desired, at least one information layer (3) which can be written on by means of light, preferably laser light, if desired a protective layer (4), if desired an adhesive layer (5) and a transparent covering layer (6) have been applied.

comprises a preferably transparent substrate (1) to whose surface at least one information layer (3) which can be written on by means of light, preferably laser light, if desired an adhesive layer (5) and a transparent covering layer (6) have been applied.

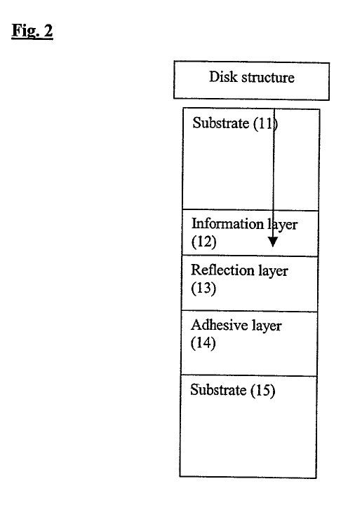

Alternatively, the optical data carrier has, for example, the following layer structure (cf. FIG. 2): a preferably transparent substrate (11), an information layer (12), if desired a reflection layer (13), if desired an adhesive layer (14), a further preferably transparent substrate (15).

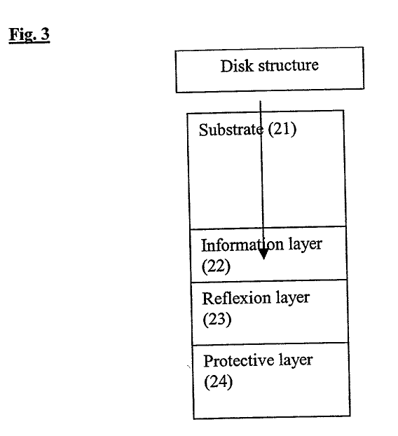

Alternatively, the optical data carrier has, for example, the following layer structure (cf. FIG. 3): a preferably transparent substrate (21), an information layer (22), if desired a reflection layer (23), a protective layer (24).

The invention further provides optical data carriers according to the invention which have been written on by means of blue, red or infrared light, in particular laser light.

In addition, the invention relates to the novel optical data stores after they have been written on once by means of blue, red or infrared light, in particular laser light.

Furthermore, the invention relates to the use of light-absorbent compounds which have at least two identical or different chromophoric centres and have at least one absorption maximum in the range from 340 to 820 nm in the information layer of write-once optical data carriers. The preferred ranges for the light-absorbent compounds and for the optical data carriers also apply to this use according to the invention.

Apart from the light-absorbent compound, the information layer may further comprise binders, wetting agents, stabilizers, diluents and sensitizers and also further constituents.

The substrates can be produced from optically transparent plastics which, if necessary, have undergone surface treatment. Preferred plastics are polycarbonates and polyacrylates, and also polycycloolefins or polyolefins. The light-absorbent compound can also be used in a low concentration to protect the polymer substrate and its light stabilization.

The reflection layer can be produced from any metal or metal alloy which is customarily utilized for writeable optical data carriers. Suitable metals or metal alloys can be applied by vapour deposition or sputtering and comprise, for example, gold, silver, copper, aluminium and alloys of these with one another or with other metals.

The protective surface coating over the reflection layer can comprise UV-curing acrylates.

An intermediate layer which protects the reflection layer from oxidation can likewise be present.

Mixtures of the abovementioned light-absorbent compounds can likewise be used.

The invention further provides a process for producing the optical data carriers of the invention, which is characterized in that a preferably transparent substrate which has, if desired, previously been provided with a reflection layer is coated with the light-absorbent compound in combination with suitable binders and, if desired, suitable solvents and is provided, if desired, with a reflection layer, further intermediate layers and, if desired, a protective layer or a further substrate or a covering layer.

Coating of the substrate with the light-absorbent compound, if desired in combination with dyes, binders and/or solvents, is preferably carried out by spin coating.

To carry out the coating procedure, the light-absorbent compound is preferably dissolved, with or without additives, in a suitable solvent or solvent mixture in such an amount that 100 parts by weight or less, for example from 10 to 2 parts by weight, of the UV absorber are present per 100 parts by weight of solvent. The writeable information layer is then metallized (reflection layer) by sputtering or vapour deposition, preferably under reduced pressure, and possibly provided subsequently with a protective surface coating (protective layer) or a further substrate or a covering layer. Multilayer assemblies with a partially transparent reflection layer are also possible.

Solvents or solvent mixtures for coating with the light-absorbent compounds or their mixtures with additives and/or binders are selected, firstly, according to their solvent capacity for the light-absorbent compound and the other additives and, secondly, so that they have a minimal effect on the substrate. Suitable solvents which have little effect on the substrate are, for example, alcohols, ethers, hydrocarbons, halogenated hydrocarbons, cellosolves, ketones. Examples of such solvents are methanol, ethanol, propanol, 2,2,3,3-tetrafluoropropanol, butanol, diacetone alcohol, benzyl alcohol, tetrachloroethane, dichloromethane, diethyl ether, dipropyl ether, dibutyl ether, methyl tert-butyl ether, methyl cellosolve, ethyl cellosolve, 1-methyl-2-propanol, methyl ethyl ketone, 4-hydroxy-4-methyl-2-pentanone, hexane, cyclohexane, ethyl-cyclohexane, octane, benzene, toluene, xylene. Preferred solvents are hydrocarbons and alcohols, since they have the smallest effect on the substrate.

Suitable additives for the writeable information layer are stabilizers, wetting agents, binders, diluents and sensitizers.

The following examples illustrate the subject-matter of the invention:

### EXAMPLES

### Example A

31.8 g of diethylene glycol, 102.1 g of cyanoacetic acid and 4 g of p-toluenesulphonic acid were refluxed in 150 ml of toluene for 12 hours using a water separator. After cooling, the mixture was stirred with 500 ml of saturated sodium hydrogen carbonate solution and extracted with 800 ml+2×100 ml of ethyl acetate. The organic phase was dried over sodium sulphate and evaporated under reduced pressure. This gave 59 g (82% of theory) of an oil of the formula

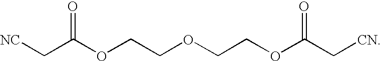

MS(CI): m/e=241 (M⁺+H).

### Example A-a

The procedure of Example A was repeated using 18.6 g of ethylene glycol and 102.1 g of cyanoacetic acid to give 44.6 g (76% of theory) of an oil of the formula

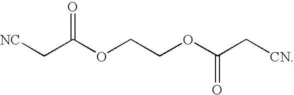

MS (CI): m/e=197 (M⁺+H).

### Example A-b

The procedure of Example A was repeated using 36.0 g of 2-(hydroxymethyl)-2-methyl-1,3-propanediol and 153.1 g of cyanoacetic acid to give 81.3 g (84% of theory) of a slowly crystallizing oil of the formula

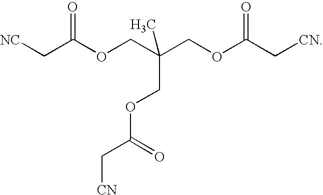

MS(CI): m/e=322 (M⁺+H).

### Example B

9.5 g of pyrrole-2-carbaldehyde were placed in a reaction vessel together with a mixture of 50 g of 25% strength by weight aqueous sodium hydroxide and 50 ml of toluene. At 75-80° C., a solution of 13.2 g of α,α′-dibromo-m-xylene in 100 ml of toluene was added dropwise. The mixture was stirred at 75-80° C. for 3.5 hours. After cooling, the organic phase was separated off, dried over sodium sulphate and evaporated under reduced pressure. This gave 14 g (96% of theory) of an oil of the formula

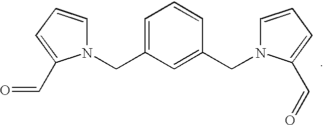

### Example B-a

The procedure of Example B was repeated using 9.5 g of pyrrole-2-carbaldehyde and 10.1 g of 1,3-dibromopropane to give 10.8 g (47% of theory) of the product of the formula

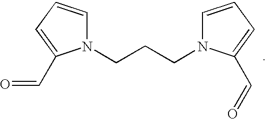

MS: m/e=230.

### Example C

7.9 g of succinyl chloride and subsequently 10.0 g of triethylamine were added dropwise to a solution of 15.1 g of N-methyl-N-(2-hydroxyethyl)aniline in 100 ml of methylene chloride. After the mixture had been boiled for 4 hours, the solvent was taken off under reduced pressure. The oily crude product was dissolved in 100 ml of toluene, filtered and filtered through 30 g of aluminium oxide. Taking off the solvent under reduced pressure gave 12.3 g (64% of theory) of an oil of the formula

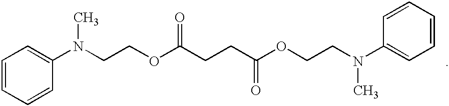

MS: m/e=384.

### Example C-a

The procedure of Example C was repeated using 18.1 g of N-ethyl-N-(2-hydroxyethyl)-m-toluidine to give 15.0 g (68% of theory) of an oil of the formula

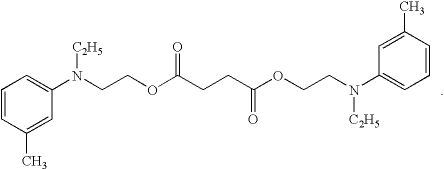

MS: m/e=440.

### Example D

21.6 g of 1,4-dibromobutane were added dropwise at 60° C. to a solution of 15.9 g of 2,3,3-trimethyl-3H-indole and 100 mg of tetrabutylammonium iodide in 50 ml of butyrolactone. After 6 hours at 90-120° C., the mixture was cooled and filtered with suction. This gave 8.2 g (30.6% of theory) of a colourless powder of the formula

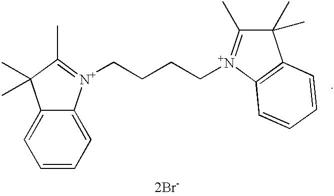

¹H-NMR (CDCl₃): δ=8.58 (d), 7.63 (m), 7.55 (d), 4.84 (m), 3.27 (s), 2.56 (m), 1.64 ppm (s).

### Example E

8.2 g of dibromo-o-xylene and 5.6 g of γ-picoline were stirred in 60 ml of γ-butyrolactone at 80° C. for 30 minutes. After cooling, the mixture was filtered with suction, the solid was washed with 2×10 ml of γ-butyrolactone and dried. This gave 8.7 g (64% of theory) of a colourless powder of the formula

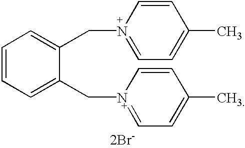

¹H-NMR ([d₆]-DMSO): δ=9.02 (d), 808 (d), 7.50 (m), 7.19 (m), 6.18 (s), 2.66 ppm (s).

### Example F

Using a procedure analogous to that described in Tetrahedron 55, (1999), 6511, the furfural derivative of the formula

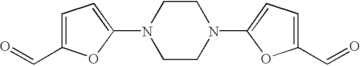

was prepared from 5-bromofuran-2-carbaldehyde and piperazine.

m.p. 235-240° C.

### Example 1

44.1 g of 3,3-dimethyl-5,6-dimethoxy-indan-1-one, 19.6 g of the product from Example A-a, 14.8 g of propionic acid, 3.6 g of ammonium acetate and 40 g of xylene were boiled for 13 hours using a water separator. After cooling, the mixture was filtered with suction and the solid was washed with 9 ml of xylene. The solid was stirred in 200 ml of water, filtered off with suction once again and washed with 200 ml of methanol. Drying under reduced pressure gave 21.7 g (36% of theory) of a pale yellow crystalline powder of the formula

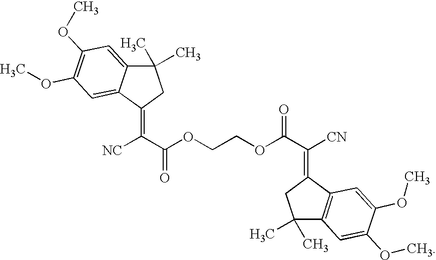

m.p. 244-248° C.,

λₘₐₓ (dioxane)=363 nm, 378 nm.

### Example 2

6.0 g of the product from Example A, 2.4 g of pyrrole-2-carbaldehyde and 2.8 g of 2-methylfurfural were dissolved in 100 ml of ethanol and admixed with 5 g of triethylamine. The mixture was stirred overnight at room temperature. The product which had precipitated was filtered off with suction, washed with 10 ml of ethanol and dried under reduced pressure. This gave 5.8 g (56.6% of theory) of a pale yellow powder of the formula

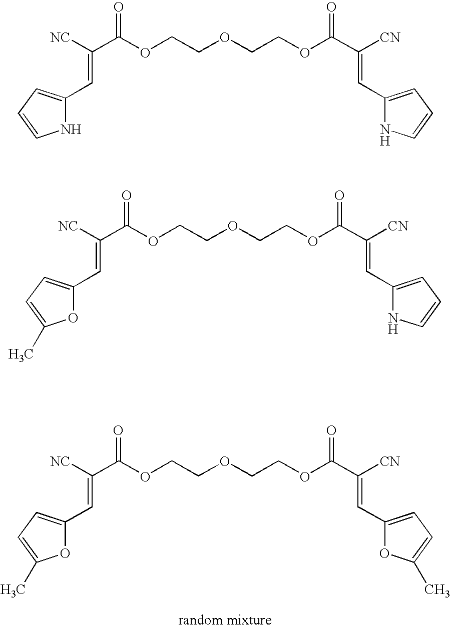

m.p. 131-135° C.

λₘₐₓ (dioxane)=359 nm.

MS(CI): m/e=395, 410,425 (M⁺+H).

### Example 3

6.4 g of the product from Example A-b and 6.6 g of 2-methylfurfural were stirred overnight in 70 ml of pyridine at room temperature. The solvent was taken off under reduced pressure, the residue was dissolved in 50 ml of acetone and once again evaporated under reduced pressure. This residue was stirred in 100 ml of water, filtered off with suction, washed with water and dried under reduced pressure. This gave 6.2 g (52% of theory) of a slightly yellowish powder of the formula

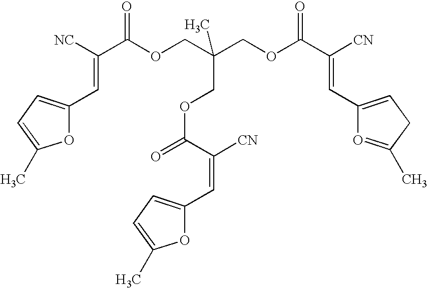

m.p. 135-140° C.

λₘₐₓ (dioxane)=354 nm.

### Example 4

2.9 g of the product from Example B and 2.6 g of propyl cyanoacetate in 30 ml of ethanol were admixed with 2 g of triethylamine and stirred overnight at room temperature. The product was filtered off with suction and washed with ethanol. Drying under reduced pressure gave 3.9 g (76% of theory) of a slightly yellowish powder of the formula

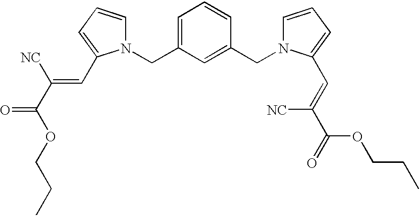

m.p. 123-125° C.

λₘₐₓ (dioxane)=370 nm.

MS: m/e=510 (M).

### Example 5

11.5 g of tetracyanoethene were added at room temperature to a solution of 18.8 g of N-methyl-N-(2-hydroxyethyl)-aniline in 30 ml of dimethylformamide at such a rate that the temperature did not exceed 50° C. This temperature was maintained for 10 minutes, the mixture was then cooled to 2° C. and filtered with suction. Drying of the solid gave 21.8 g (96% of theory) of red crystalline powder of the formula

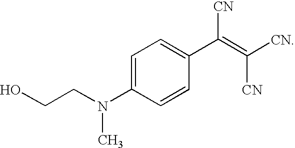

5.1 g of this dye in 50 ml of ethylene chloride were admixed with 2.1 g of succinyl chloride and subsequently with 2 g of triethylamine. The mixture was refluxed for 8 hours. After cooling, the mixture was filtered and the filtrate was evaporated under reduced pressure. The residue was stirred in 50 ml of ethanol at room temperature, filtered off with suction, stirred in 500 ml of water at room temperature, filtered off with suction once again and dried. This gave 2.4 g (41% of theory) of a red powder of the formula

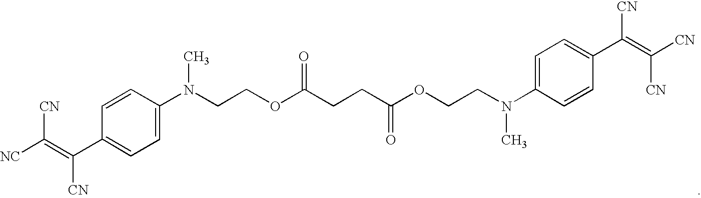

m.p. 292-299° C.

λₘₐₓ (dioxane)=493 nm.

ε=64340 l/mol cm.

solubility: 1% in TFP.

### Example 6

The same product was obtained by reacting 7.7 g of the product from Example C with 5.6 g of tetracyanoethene in 15 ml of dimethylformamide at 50° C. for 10 minutes.

### Example 7

10.8 g of 4-aminophthalonitrile were introduced into a mixture of 105 ml of glacial acetic acid, 37 ml of propionic acid and 26 ml of concentrated hydrochloric acid. 24.8 ml of nitrosylsulphuric acid were added dropwise at 0-5° C. and the mixture was stirred at this temperature for another 30 minutes.

This diazotization product was added dropwise at 10° C. to a solution of 18.6 g of 2-(N-ethyl-3-methylanilino)ethyl methacrylate in a mixture of 60 ml of glacial acetic acid and 0.5 g of amidosulphonic acid over a period of 1 hour, with the pH being raised to 3 by dropwise addition of 20% strength by weight sodium carbonate solution. The mixture was stirred overnight at room temperature and pH=3. It was then filtered with suction. The crude product was stirred in 300 ml of water and the pH was adjusted to 7.5 by means of 20% strength by weight sodium carbonate solution. The mixture was filtered with suction once again, the solid was washed with water and dried under reduced pressure. This gave 26.0 g (86.5% of theory) of a red crystalline powder of the formula

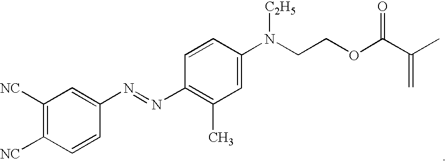

m.p. 95-110° C.

λₘₐₓ (dioxane)=479 nm.

ε=33040 l/mol cm.

### Example 8

2 g of this dye from Example 7 were stirred with 0.1 g of 2,2′-azobis-(2-methylpropionitrile) and 0.5 g of triethylamine in 20 ml of dimethylformamide at 70° C. under a nitrogen atmosphere for 25 hours. After cooling, 150 ml of water were added dropwise. The product which had precipitated was filtered off with suction, washed with water and dried. This gave 1.9 g (95% of theory) of the polymer of the formula

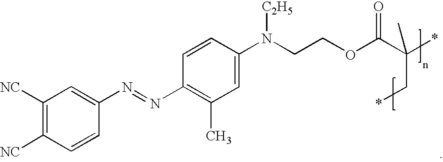

solubility: 0.3% in TFP.

### Example 9

5.8 g of the product from Example B-a and 5.9 g of benzyl cyamide were dissolved in 100 ml of ethanol. 4 ml of 50% strength by weight aqueous sodium hydroxide were added dropwise. After the mixture had been stirred at room temperature for 3 hours, 4 ml of glacial acetic acid were added and the precipitated solvent was filtered off with suction, washed with ethanol and dried. This gave 3.0 g (28% of theory) of the product of the formula

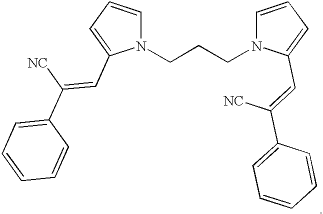

m.p. 123-127° C.

λₘₐₓ (dioxane)=366 nm.

δ=49860 l/mol cm.

MS: m/e=428 (M⁺).

solubility: 2% in diacetone alcohol.

### Example 10

2.7 g of the furfural derivative from Example F and 2.8 g of dimedone were stirred in 50 ml of acetic anhydride at 80° C. for 30 minutes. After cooling, the mixture was poured into 200 ml of water. This gave, after drying, 3.0 g (58% of theory) of a red powder of the formula

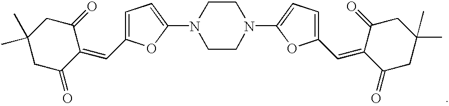

m.p. 230-235° C.

λₘₐₓ (dioxane)=495 nm.

δ=76250 μl/mol cm.

solubility: 2% in TFP.

### Example 11

2.0 g of dibromo-o-xylene were added dropwise at 70° C. to a solution of 5 g of the dye of the formula

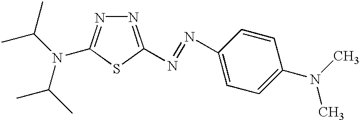

prepared by a method analogous to Example 1 of DE-A 29 11 258) in 25 ml of y-butyrolactone. After 27 hours at 70° C., the mixture was cooled, poured into 200 ml of water, admixed with 1 g of activated carbon and thus clarified, and the product was salted out by addition of sodium chloride. Filtration with suction and drying gave 6.2 g (89% of theory) of the dye of the formula

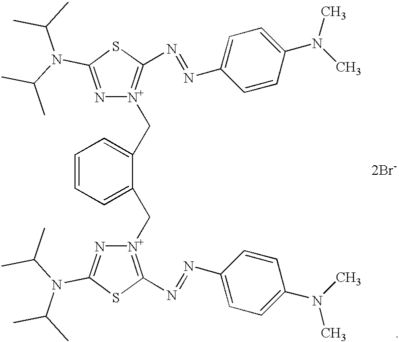

1.4 g of this dye were refluxed in 20 ml of methanol. 2 g of tetrabutylammonium tetrafluoroborate were added. After refluxing for 10 minutes, the mixture was cooled, filtered with suction, the solid was washed with methanol and dried. This gave 1.2 g (85% of theory) of the dye of the formula

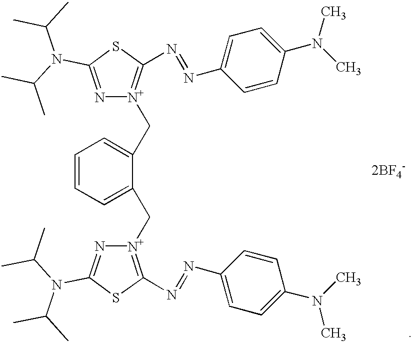

λₘₐₓ (methanol/glacial acetic acid 9:1)=567, 615 nm.

ε(567 nm)=90520.

### Example 12

13.5 g of the product from Example E were introduced into 30 ml of glacial acetic acid. 30 ml of piperidine were slowly added to this mixture, with the temperature rising to 80° C. 10.8 g of 4-(diethylamino)benzaldehyde were sprinkled in. After 2 hours at 80° C., the mixture was cooled and poured into 500 ml of water. Filtration with suction and drying gave 17.2 g (74% of theory) of a blackish red powder of the formula

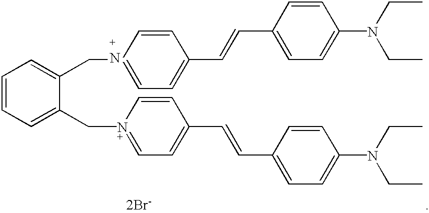

¹H-NMR ([d₆]-DMSO): δ=8.76 (d), 8.08 (d), 7.58 (d), 7.52 (m), 7.28 (m), 7.16 (d, —CH═CH—), 6.74 (d), 5.98 (s), 3.45 (q), 1.13 ppm (t).

7.7 g of this dye in 170 ml of methanol were admixed at the boiling point with 13.2 g of tetrabutylammonium tetrafluoroborate. After refluxing for 15 minutes, the mixture was cooled, filtered with suction, the solid was washed with 30 ml of methanol in which 1 g of tetrabutylammonium tetrafluoroborate had been dissolved and subsequently with 3×10 ml of methanol and dried. This gave 5.8 g (74% of theory) of a blackish blue powder of the formula

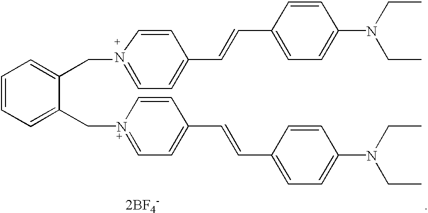

m.p. 264-266° C.

λₘₐₓ (methanol/glacial acetic acid 9:1)=504 nm

ε=90535 l/mol cm

solubility: 2% in TFP

### Example 13

The procedure of Example 12 was repeated using the product from Example D and N-methyl-N-cyanoethylbenzaldehyde to give the dye of the formula

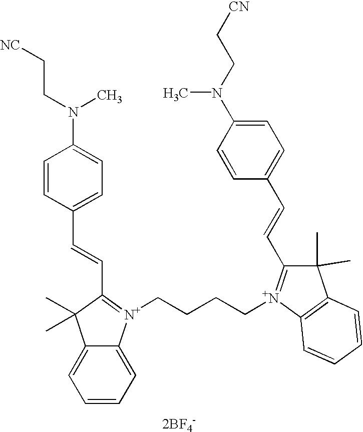

in a yield of 49% of theory.

m.p.>300° C.

λₘₐₓ (DMF)=532 run

ε=84550 l/mol cm

solubility: 2% in TFP

### Example I (Comparative Example)

A 1/1 mixture (by mass) of substances of the following formulae was dissolved in tetrafluoropropanol (TFP) in a mass ratio of 2 parts of solid to 98 parts of TFP. This solution was applied by spin coating to a fused silica support and gave a transparent film. Evaluation of the transmission and reflection spectra indicated a film thickness of 165 nm.

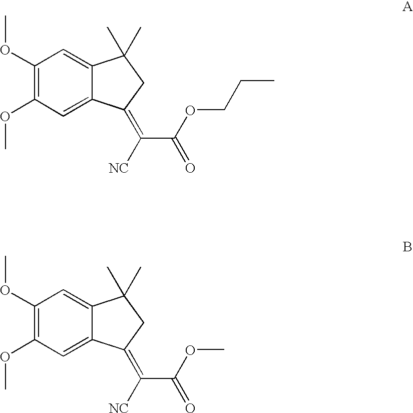

This film was subjected to a vacuum (pressure ˜10⁻⁶ mbar) for 1 hour at room temperature to simulate the conditions when applying metallic or dielectric layers by sputtering during the production of optical data carriers. After this vacuum treatment, the total thickness d of the layer evaluated by the above-described method was 0 nm, i.e. all of the substance has sublimed.

### Example II

The substance of the following formula, which represents the dimer of the substance B in Example I, was synthesized as described in Example 1. The substance was dissolved in tetrafluoropropanol (TFP) in a mass ratio of 1 part of solid to 99 parts of TFP. This solution was applied by spin coating to a fused silica support and gave a transparent film. Evaluation of the transmission and reflection spectra indicated a film thickness of 85 nm.

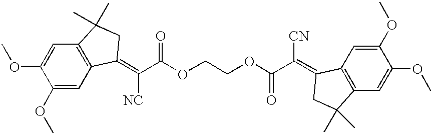

This film was subjected to a vacuum (pressure ˜10⁻⁶ mbar) for 1 hour at room temperature to simulate the conditions when applying metallic or dielectric layers by sputtering during the production of optical data carriers. After this vacuum treatment, the total thickness d of the layer evaluated by the above-described method was 85 nm, i.e. the substance has been fully retained.

### Example III

The substance of the following formula, prepared as described in WO 9851721, was dissolved in tetrahydrofuran (THF) in a mass ratio of 2 parts of solid to 98 parts of THF. This solution was applied by spin coating to a fused silica support and gave a transparent film. Evaluation of the transmission and reflection spectra indicated a film thickness of 90 nm.

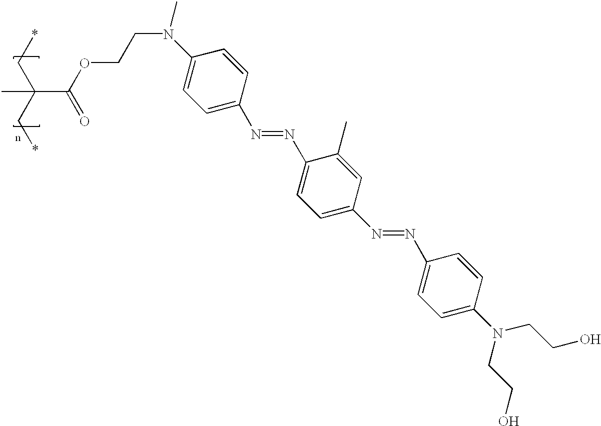

This film was subjected to a vacuum (pressure ˜10⁻⁶ mbar) for 1 hour at room temperature to simulate the conditions when applying metallic or dielectric layers by sputtering during the production of optical data carriers. After this vacuum treatment, the total thickness d of the layer evaluated by the above-described method was 91 nm, i.e. the substance has been fully retained.

A layer of SiN was subsequently applied by vapour deposition on top of the layer which had been pretreated in the above-described manner. Vapour deposition was carried out by electric heating of Si₃N₄ in a molybdenum boat under reduced pressure. The pressure during the vapour deposition process was ˜10⁻⁴ mbar, and the deposition rate was ˜4-5 Angström per second. To determine the complex index of refraction of the deposited SiN layer, control experiments were carried out on plain fused silica plates. The thickness of the SiN layer was determined by means of a profiler (Tencor Alpha Step 500 Surface Profiler). In turn, evaluation of the transmission and reflection spectra of the layer system taking into account the complex index of refraction and the thickness of the SiN layer enabled the apparent thickness of the organic film to be determined. It was 94 nm. This shows that the layer has not been changed by the vapour deposition process and that a sharp boundary between organic layer and SiN has been obtained.

### Example IV

The substance of the following formula was dissolved in tetrafluoropropanol (TFP) in a mass ratio of 1 part of solid to 99 parts of TFP. This solution was applied by spin coating to a fused silica support and gave a crystalline film.

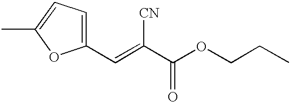

### Example V

The substance of the following formula, which represents the branched trimer of the substance from Example IV, was synthesized as described in Example 3. The substance was dissolved in tetrafluoropropanol (TFP) in a mass ratio of 1 part of solid to 99 parts of TFP. This solution was applied by spin coating to a fused silica support and gave a transparent film. Evaluation of the transmission and reflection spectra indicated a film thickness of 153 nm.

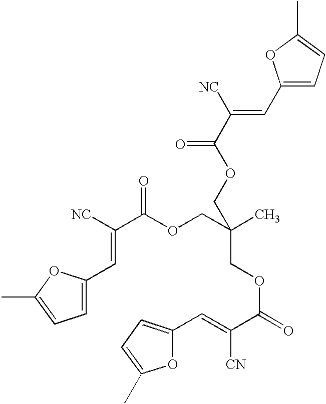

This film was subjected to a vacuum (pressure ˜10⁻⁶ mbar) for 1 hour at room temperature to simulate the conditions when applying metallic or dielectric layers by sputtering during the production of optical data carriers. After this vacuum treatment, the total thickness d of the layer evaluated by the above-described method was 143 nm, i.e. the substance has been virtually fully retained.

A layer of SiN was subsequently applied by vapour deposition on top of the layer which had been pretreated in the above-described manner. Vapour deposition was carried out by electric heating of Si₃N₄ in a molybdenum boat under reduced pressure. The pressure during the vapour deposition process was ˜10⁻⁴ mbar, and the deposition rate was ˜4-5 Angström per second. To determine the complex index of refraction of the deposited SiN layer, control experiments were carried out on plain fused silica plates. The thickness of the SiN layer was determined by means of a profiler (Tencor Alpha Step 500 Surface Profiler). In turn, evaluation of the transmission and reflection spectra of the layer system taking into account the complex index of refraction and the thickness of the SiN layer enabled the apparent thickness of the organic film to be determined. It was 160 nm. This shows that, within measurement errors, the layer has not been changed by the vapour deposition process and that a sharp boundary between organic layer and SiN has been obtained.

Determination of the complex index of refraction and the thickness of the layer of the organic substances by means of transmission and reflection spectra:

The transmission and reflection spectra of the layer systems film/fused silica or SiN/film/fused silica or SiN/fused silica were determined with perpendicular incidence of a parallel beam of light in a wavelength range of from 200 nm to 1 700 nm. The fused silica substrates had a thickness of 1 mm. The reflected light was detected at an angle of 172° relative to the direction of incidence. Two different thicknesses of the organic film were in each case produced by spin coating. The thickness of the layer was adjusted by means of the solution concentration. The thicknesses were in the range from 50 nm to 500 nm. To evaluate the transmission and reflection spectra, the known Fresnel formulae were employed and the interferences caused by multiple reflection in the layer system were taken into account. A simultaneous least squares fit of the measured transmission and reflection spectra to the calculated spectra of the two layer systems of differing thickness enabled the layer thicknesses and the complex index of refraction of the organic substance to be determined at each wavelength. For this purpose, the index of refraction of the fused silica support has to be known. The index of refraction curve of the fused silica substrate in this spectral range was determined independently on an uncoated substrate.

### Example VI

A 3% strength by weight solution of a dye mixture consisting of 91.4% by weight of the dye of the formula

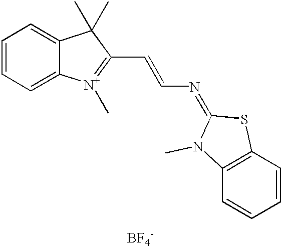

and 8.6% by weight of the polymeric dye from Sample 13d having the formula

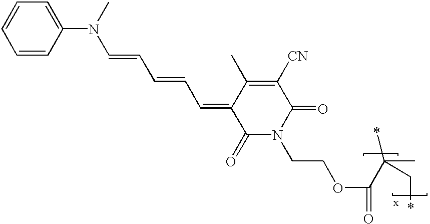

in 2,2,3,3-tetrafluoropropanol was prepared at room temperature. This solution was applied by means of spin coating to a pregrooved polycarbonate substrate. The pregrooved polycarbonate substrate had been produced as a disk by means of injection moulding. The dimensions of the disk and the groove structure corresponded to those customarily used for DVD-Rs. The disk with the dye layer as information carrier was coated with 100 nm of silver by vapour deposition. A UV-curable acrylic coating composition was subsequently applied by spin coating and cured by means of a UV lamp. The disk was tested by means of a dynamic writing test apparatus constructed on an optical tester bench comprising a diode laser (λ=656 nm) for generating linearly polarized light,. a polarization-sensitive beam splitter, a λ/4 plate and a movably suspended collecting lens having a numerical aperture NA=0.6 (actuator lens). The light reflected from the reflection layer of the disk was taken out from the beam path by means of the abovementioned polarization-sensitive beam splitter and focused by means of an astigmatic lens onto a four-quadrant detector. At a linear velocity V=3.5 m/s and a writing power P_{w}=10.5 mW, a signal/noise ratio C/N=50 dB was measured. The writing power was applied as an oscillating pulse sequence, with the disk being irradiated alternately for 1 is with the abovementioned writing power P_{w} and for 4 μs with the reading power Pᵣ≈0.6 mW. The disk was irradiated with this oscillating pulse sequence until it had rotated once. The marking produced in this way was then read using the reading power Pᵣ≈0.6 mW and the abovementioned signal/noise ratio C/N was measured.

### Example VII

Using an analogous procedure, a disk was produced using a dye mixture consisting of 85% by weight of the dye of the formula

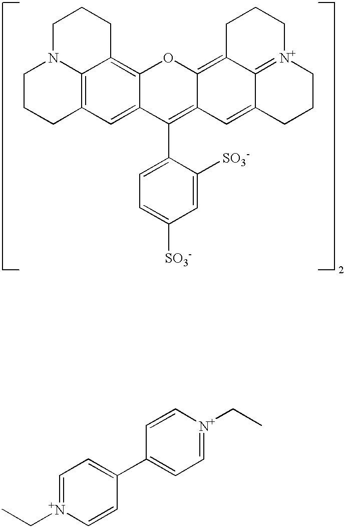

and 15% by weight of the polymeric dye from Sample 13d having the formula

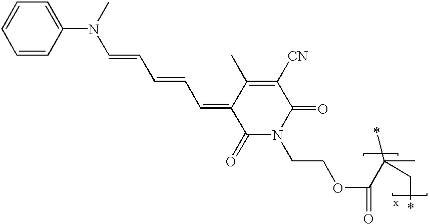

and measured. At a writing power P_{w}=10.5 mW, a C/N=44 dB was obtained.

1. Optical data carrier comprising a preferably transparent substrate which may, if desired, have previously been coated with one or more reflection layers and to whose surface a light-writeable information layer, if desired one or more reflection layers and if desired a protective layer or a further substrate or a covering layer have been applied, which can be written on or read by means of blue, red or infrared light, preferably laser light, where the information layer comprises a light-absorbent compound and, if desired, a binder, characterized in that the light-absorbent compound has at least two identical or different chromophoric centres and has at least one absorption maximum in the range from 340 to 820 nm.

2. Optical data carrier according to claim 1, characterized in that the light-absorbent compound is in the form of polymer, dendrimer or another form.

3. Optical data carrier according to claim 1, characterized in that the light-absorbent compound has the formula (I) or (II) or is a polymer having a main chain acting as backbone and covalently bound side groups of the formula (III) branching off therefrom, where the polymer has a degree of polymerization of from 2 to 1 000
F¹—(BF²)ₙBF¹ (I)
DF¹ₖ (II)
—S—F¹ (III)
where
F¹ represents a monovalent chromophoric centre,
F² represents a bivalent chromophoric centre,
B represents a bivalent bridge —B¹— or —(B²F¹)— or —(B³F¹₂)—, where
B² is a trivalent radical and
B³ is a tetravalent radical,
D represents a dendritic structure of the generation 2¹,
S represents a bivalent spacer group,
n represents an integer from 0 to 1 000,
l represents an integer from 0 to 6 and
k represents the number 3·2¹ or 4·2¹.

4. Optical data carrier according to claim 1, characterized in that the light-absorbent compound used is one which has an absorption maximum λₘₐₓ₁ in the range from 340 to 410 nm or an absorption maximum λₘₐₓ₂ in the range from 400 to 650 nm or an absorption maximum λₘₐₓ₃ in the range from 630 to 820 nm, where the wavelength λ_{1/2} at which the absorbance in the long wavelength flank of the absorption maximum at the wavelength λₘₐₓ₁, λₘₐₓ₂ or λₘₐₓ₃ or the absorbance in the short wavelength flank of the absorption maximum at the wavelength λₘₐₓ₂ or λₘₐₓ₃ is half the absorbance at λₘₐₓ₁, λₘₐₓ₂ or λₘₐₓ₃ and the wavelength λ_{1/10} at which the absorbance in the long wavelength flank of the absorption maximum at the wavelength λₘₐₓ₁, λₘₐₓ₂ or λₘₐₓ₃ or the absorbance in the short wavelength flank of the absorption maximum at the wavelength λₘₐₓ₂ or λₘₐₓ₃ is one tenth of the absorbance at λₘₐₓ₁, λₘₐₓ₂ or λₘₐₓ₃ are preferably not more than 80 nm apart in each case.

5. Optical data carrier according to one or more of claims 1 to 3, characterized in that the light-absorbent compound used has the formula (I) or (II),
where 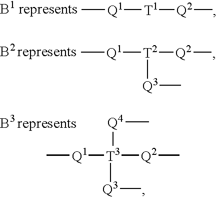
D represents a radical of the formula 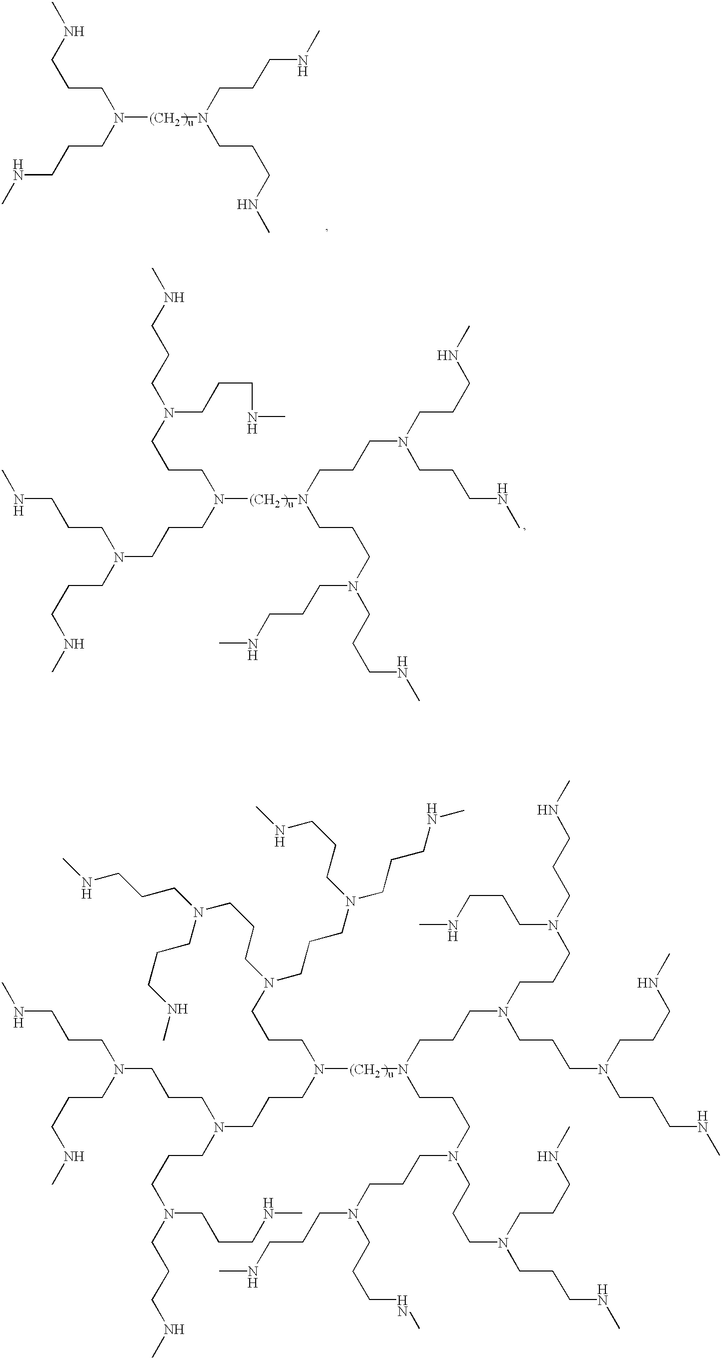
Q¹ to Q⁶ represent, independently of one another, a direct bond, —O—, —S—, —NR¹—, —C(R²R³)—, —(C═O)—, —(CO—O)—, —(CO—NR¹)—, —(SO₂)—, —(SO₂—O)——(SO₂—NR¹)—, —(C═NR⁴)—, —(CNR¹—NR¹)—, —(CH₂)ₚ—, —(CH₂CH₂O)ₚ—CH₂CH₂—, o-, m- or p-phenylene, where the chain —(CH₂)ₚ— may be interrupted by —O—, NR¹ or —OSiR⁵₂O—,
T¹ and T⁴ represent a direct bond, —(CH₂)ₚ— or o-, m- or p-phenylene, where the chain CH₂)ₚ— may be interrupted by —O—, —NR¹—, —N⁺(R¹)²— or —OSiR⁵₂O—,
T² represents 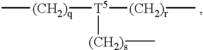
—(CH₂)_{q}—T⁵—(CH₂)ᵣ—I (CH₂)ₛ—,
where the chains —(CH₂)_{q}—, —(CH₂)ᵣ— and/or —(CH₂)ₛ— may be interrupted by —O—, —NR¹— or —OSiR⁵₂O—,
T³ represents 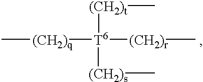
T⁵ represents CR⁶, N or a trivalent radical of the formula 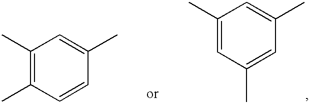
T6 represents C, Si(O—)₄, >N—(CH₂)ᵤ—N< or a tetravalent radical of the formula 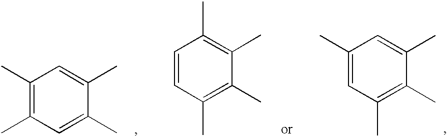
p represents an integer from 1 to 12,
q, r, s and t represent, independently of one another, an integer from 0 to 12,
u represents an integer from 2 to 4,
R¹ represents hydrogen, C₁-C₁₂-alkyl, C₃-C₁₀-cycloalkyl, C₂-C₁₂-alkenyl, C₆-C₁₀-aryl, C₁-C₁₂-alkyl-(C═O)—, C₃-C₁₀-cycloalkyl-(C═O)—, C₂-C₁₂-alkenyl-(C═O)—, C₆-C₁₀-aryl-(C═O)—, C₁-C₁₂-alkyl-(SO₂)—, C₃-C₁₀-cycloalkyl-(SO₂)—, C₂-C₁₂-alkenyl-(SO₂)— or C₆-C₁₀-aryl-(SO₂)—,
R² to R⁴ and R⁶ represent, independently of one another, hydrogen, C₁-C₁₂-alkyl, C₃-C₁₀-cycloalkyl, C₂-C₁₂-alkenyl, C₆-C₁₀-aryl,
R⁵ represents methyl or ethyl, and
the other radicals are as defined above.

6. Optical data carrier according to claim 2, characterized in that the light-absorbent compound used is a polymer having radicals of the formula (III) where the polymer chain is built up on the basis of identical or different structural elements K and
K represents a structural element of a poly-acrylate, -methacrylate, -acrylamide, -methacrylamide, -siloxane, -x-oxirane, -ether, -amide, -urethane, -urea, -ester, -carbonate, -styrene or -maleic acid.

7. Use of light-absorbent compounds in the information layer of write-once optical data carriers, where the light-absorbent compound has an absorption maximum λₘₐₓ₁ in the range from 340 to 820 nm, characterized in that the light-absorbent compound has at least two identical or different chromophoric centres.

8. Process for producing the optical data carrier according to claim 1, which is characterized in that a preferably transparent substrate which has, if desired, previously been coated with a reflection layer is coated with the light-absorbent compound, if desired in combination with suitable binders and additives and, if desired, suitable solvents, and is provided, if desired, with a reflection layer, further intermediate layers and, if desired, a protective layer or a further substrate or a covering layer.

9. Optical data carrier according to claim 1 which can be written on by means of blue, red or infrared light, in particular laser light.
